(19) United States
(12) Patent Application Publication
(10) Pub. No.: US 2008/0242321 A1
(43) Pub. Date: Oct. 2, 2008

(54) RADIO COMMUNICATION SYSTEM, BASE STATION APPARATUS, AND TERMINAL APPARATUS

(75) Inventors: Kaoru Inoue, Machida-shi (JP); Koichiro Ban, Kawasaki-shi (JP); Takahiro Kobayashi, Kawasaki-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/020,173

(22) Filed: Jan. 25, 2008

(30) Foreign Application Priority Data
Mar. 26, 2007 (JP) 2007-079971

(51) Int. Cl. H04Q 7/20; H04B 1/38; H04M 1/00

(52) U.S. Cl. 455/458; 455/561; 455/422.1

(57) ABSTRACT

A base station apparatus includes a first transmission unit configured to transmit area common information common to all base station apparatuses in an area by using not less than one time slot of not less than one common time slot assigned to each of a plurality of areas including a plurality of base station apparatuses, the common time slot being assigned to adjacent areas which are different from each other, a carrier sense unit configured to perform carrier sense on a first time slot except for the common time slot, a selection unit configured to select a second time slot determined as being available by the carrier sense, and a second transmission unit configured to intermittently transmit a control signal unique to the base station apparatus in the second time slot at K (K positive integer) time slot periods.

### CROSS-REFERENCE TO RELATED APPLICATIONS

This application is based upon and claims the benefit of priority from prior Japanese Patent Application No. 2007-079971, filed Mar. 26, 2007, the entire contents of which are incorporated herein by reference.

### BACKGROUND OF THE INVENTION

1. Field of the Invention

The present invention relates to a frame arrangement for the assignment of control channels of a radio communication system, a transmission method for a terminal call signal, and a procedure from a terminal calling operation to a responding operation, and further relates to a radio communication system, base station apparatus, and terminal apparatus which implements the procedure.

2. Description of the Related Art

Cellular mobile radio communication systems, in which a radio communication range is divided into a plurality of regions called cells, and the cells are arranged around radio base stations with no space between them, include a microcellular system comprising relatively small cells each having a radius equal to or less than several hundred meters. PHS (Personal Handy-phone System) is a typical system using the microcellular system.

PHS uses TDM (Time Division Multiplexing) for a downlink from a base station to a terminal and TDMA (Time Division Multiple Access) for an uplink from a terminal to a base station. PHS also uses TDD (Time Division Duplex) using the same frequency for an uplink and downlink. In PHS, one frame comprises several time slots on an uplink and several time slots on a downlink, and communication is performed by using some of the time slots. Each base station confirms by itself that a given time slot on a control signal channel is not used by other base stations, at the time of initial startup or re-startup or when no connection is made to a terminal, for example, late at night or during a maintenance period, and intermittently transmits control information unique to each base station in the slot at a predetermined period. Letting a plurality of base stations independently use different time slots allows the base stations to time-divisionally multiplex control signals on the same control signal frequency channel and transmit the signals to terminals. For example, each base station time-divisionally and intermittently transmits control information while ensuring one of different time slots for every L (L is an integer equal to or more than one) frames. In this case, each base station can transmit a control signal at a frequency of one time slot per L frames. In addition, each base station further time-divisionally multiplexes and transmits a plurality of different types of control information in a period during which one slot can be used per L frames, i.e., an intermittent transmission period of a downlink control signal (see, for example, ARIB Standard STD-T28 Version 5.2 Sections 4.25 and 4.2.6).

In PHS, since each base station transmits control signals with the above arrangement, increasing the time interval of intermittent transmission makes it possible to increase the number of base stations which can multiplex signals on one frequency channel. On the other hand, this increases the interval during which a control signal can be transmitted, and hence decreases the control channel transmission capacity of each base station.

In PHS, base stations transmit even the same control information common to them by individually using necessary time slots, and hence the use of frequencies is inefficient.

### BRIEF SUMMARY OF THE INVENTION

In accordance with a first aspect of the invention, there is provided a base station apparatus comprising: a first transmission unit configured to transmit area common information common to all base station apparatuses in an area by using not less than one time slot of not less than one common time slot assigned to each of a plurality of areas including a plurality of base station apparatuses, the common time slot being assigned to adjacent areas which are different from each other; a carrier sense unit configured to perform carrier sense on a first time slot except for the common time slot assigned to the area to which the base station apparatus belongs; a selection unit configured to select a second time slot determined as being available by the carrier sense; and a second transmission unit configured to intermittently transmit a control signal unique to the base station apparatus in the second time slot at K (K: positive integer) time slot periods.

In accordance with a second aspect of the invention, there is provided a radio communication system which includes a plurality of base station apparatuses and a plurality of terminal apparatuses which perform radio communication by using time divided time slots,

each base station apparatus comprising: a first transmission unit configured to transmit paging information for paging not less than one terminal apparatus as area common information common to all base station apparatuses in an area to which the base station apparatus belongs by using a common time slot common to the area, not less than one common time slot being assigned to each area including a plurality of base station apparatuses, different common time slots being assigned to adjacent areas; a carrier sense unit configured to perform carrier sense on a first time slot except for the common time slot assigned to the area to which the base station apparatus belongs; a first selection unit configured to select a second time slot determined as being available by the carrier sense; and a second transmission unit configured to intermittently transmit a first control signal unique to the base station apparatus in the second time slot at K (K: positive integer) time slot periods, and

each terminal apparatus comprising: a reception unit configured to receive the paging information; a second selection unit configured to select a connection destination base station apparatus to which the terminal apparatus is to connect from a plurality of surrounding base station apparatuses when the paging information paging the terminal apparatus; and a third transmission unit configured to transmit a response signal to the connection destination base station apparatus in a third time slot corresponding to a time slot which transmits a second control signal unique to the connection destination base station apparatus.

In accordance with a third aspect of the invention, there is provided a terminal apparatus in a radio communication system, the apparatus comprising: a first reception unit configured to receive paging information which pages a terminal apparatus as area common information common to all base station apparatuses in an area by using not less than one time slot of not less than one common time slot assigned to each area including a plurality of base station apparatuses, the common time slots being assigned to adjacent areas which are different from each other; a transmission unit configured to transmit a response signal corresponding to the paging information; and a second reception unit configured to receive unique control information of a base station apparatus which is transmitted by a first time slot other than a second time slot in which the paging information is transmitted, the first time slot being included in the common time slots.

### BRIEF DESCRIPTION OF THE SEVERAL VIEWS OF THE DRAWING

FIG. 1 is a block diagram of a base station according to the first embodiment;

FIG. 2 is a block diagram of a terminal according to the first embodiment;

FIG. 3 is a view showing the arrangement of uplink and downlink slots constituting a frame in the embodiments;

FIGS. 4A to 4D are views each of which shows the arrangement of control slots among time slots in the embodiments;

FIG. 5 is a view showing each cell in which each base station is placed and each area in the embodiments;

FIG. 6 is a view showing the relationship between slot groups C, slot groups B, and a fundamental period unit A which are assigned to each area shown in FIG. 5;

FIG. 7 is a view showing the relationship between the period of time slots for the transmission of control information unique to a base station and the fundamental period unit A in FIG. 6;

FIG. 8 is a view showing the relationship between the period of time slots for the transmission of control information unique to a base station and the fundamental period unit A in FIG. 6;

FIGS. 9A and 9B are views each of which shows an example of assigning one slot to each area;

FIG. 10 is a view showing the usage rates of slots at the center of a call area and area boundaries in the slot assignment shown in FIG. 9;

FIG. 11 is a flowchart showing an example of a processing procedure for base stations and a terminal in the first embodiment;

FIG. 12 is a block diagram of a base station according to the second embodiment;

FIG. 13 is a view showing an example of assigning two slots to each area;

FIG. 14 is a view showing the usage rates of slots at the center of a call area and area boundaries in the slot assignment shown in FIG. 13;

FIG. 15 is a view showing a base station controller which comprehensively controls all the base stations in an area and the area;

FIG. 16 is a flowchart showing an example of a processing procedure for base stations, a terminal, and a base station controller in the second embodiment;

FIG. 17 is a block diagram of a base station according to the third embodiment;

FIG. 18 is a block diagram of a terminal according to the third embodiment;

FIG. 19 is a flowchart showing an example of a processing procedure for base stations and a terminal in the third embodiment;

FIG. 20 is a view showing a orthogonal code sequence individually assigned, as information unique to each base station, to each base station;

FIG. 21 is a view showing a signal common to all base stations in an area and a signal unique to each base station which are contained in one time slot;

FIG. 22 is a block diagram of a base station according to the fourth embodiment; and

FIG. 23 is a flowchart showing an example of a processing procedure for base stations and a terminal in the fourth embodiment.

### DETAILED DESCRIPTION OF THE INVENTION

A radio communication system, base station apparatus, and terminal apparatus according to embodiments will be described below with reference to the views of the accompanying drawing. Note that the same reference numerals denote the parts which perform the same operations in the following embodiments, and a repetitive description will be omitted. In addition, a base station apparatus and a terminal apparatus will be simply referred to as a base station and a terminal, respectively.

According to the radio communication system, base station apparatus, and terminal apparatus of the embodiments, it is possible to provide a time slot assignment arrangement which increases the transmission capacity of a control information channel and performs efficient communication control with respect to the arrangement.

An outline of the embodiments will be described first.

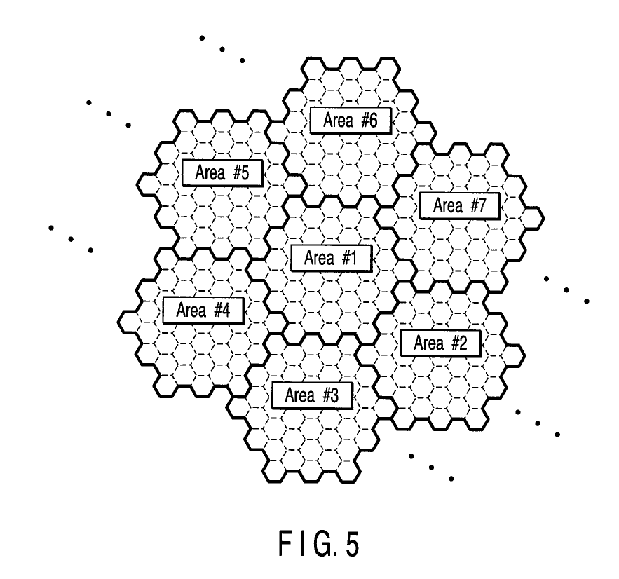

In the embodiments, a plurality of base stations transmit control information common to them while sharing a specific time slot, instead of individually using different time slots, for each area where common control information is to be transmitted (in all embodiments). In this case, an area is defined as a range comprising a plurality of regions called cells in which base stations are arranged. More specifically, although described in detail in the following embodiment, for example, as shown in FIG. 5, a range comprising a plurality of cells (hexagons in FIG. 5) in which base stations are arranged is defined as one area.

Assume that area common control information to be transmitted on an area basis by sharing a time slot is area-basis terminal paging information. This paging information contains the identification information of each terminal to be called on an area basis.

In addition, if OFDM (Orthogonal Frequency Division Multiplexing) is to be used as a radio transmission system, an SFN (Single Frequency Network) can be implemented by making the respective base stations transmit the same signal by using the same time slot in the same frequency band.

When a plurality of base stations in an area transmit paging information over the same signal, although the base stations can transmit the identification information of each called terminal, a terminal which has received paging information cannot specify the base station which has transmitted the paging information, and needs to determine to which base station the terminal should return a response. With regard to this determination, the embodiments will exemplify a case (first and third embodiments) wherein a terminal determines to which base station it should return a response, a case (second embodiment) wherein an external control apparatus (corresponding to a base station controller to be described later) performs determination and issues an instruction to a terminal through a base station, and a case (fourth embodiment) wherein a terminal specifies the position of a time slot unique to a base station to which the terminal returns a response.

Assume that in the following embodiments, the radio access system to be used is OFDMA/TDMA, and the radio duplex system to be used is TDD. However, the radio access system to be used is not limited to OFDMA, and, for example, the single carrier system to which a single prefix is added may be used.

### FIRST EMBODIMENT

In the first embodiment, all the base stations in each area transmit the same signal by using a time slot assigned to each area in advance. Each base station checks whether a time slot assigned to an area other than the area to which it itself belongs is not used by other base stations. The base station uses the time slot which is confirmed as not being used to intermittently transmit control information unique to itself.

In the first embodiment, a terminal selects a connection destination base station on the basis of common call signals transmitted from base stations.

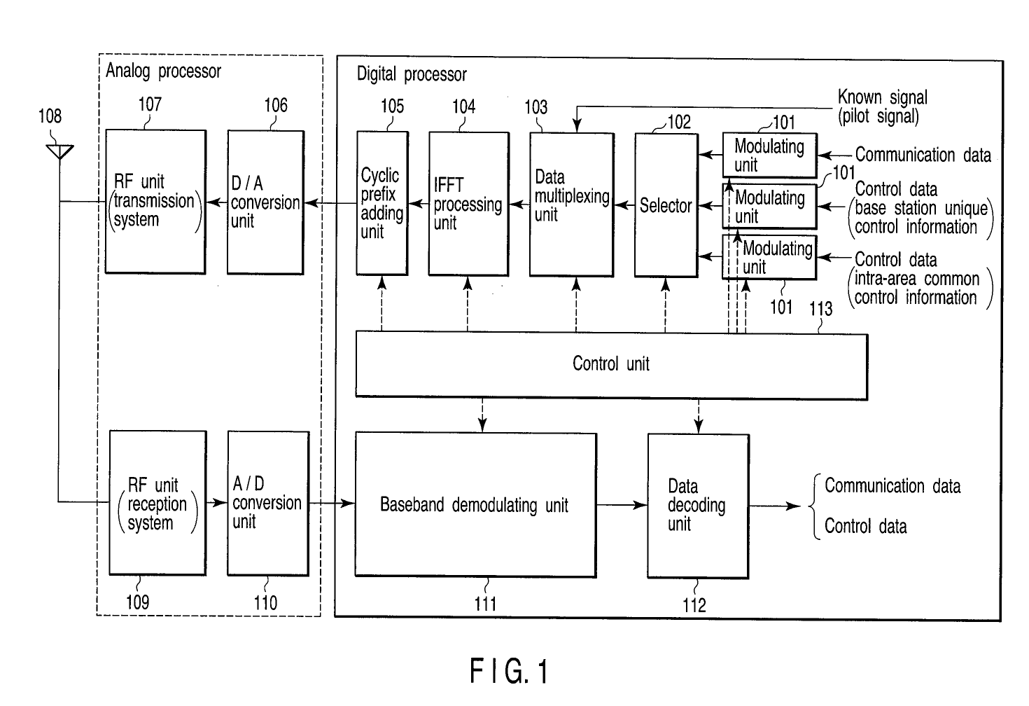

A base station according to this embodiment will be described with reference to FIG. 1.

A base station according to this embodiment includes a modulating unit 101, selector 102, data multiplexing unit 103, IFFT (Inverse Fast Fourier Transform) processing unit 104, cyclic prefix adding unit 105, D/A (Digital-to-Analog) conversion unit 106, RF unit (transmission system) 107, transmission/reception antenna 108, RF unit (reception system) 109, A/D (Analog-to-Digital) conversion unit 110, baseband demodulating unit 111, data decoding unit 112, and control unit 113.

The modulating unit 101 modulates communication data and control data (control information unique to the base station or common control information which is k common within an area). All the base stations in the area transmit control information common within the area by using a time slot determined in advance for each area.

The selector 102 selects one of the communication data and control data and outputs it to the data multiplexing unit 103. The data multiplexing unit 103 multiplexes a known signal such as a pilot signal with the data selected by the selector 102. The IFFT processing unit 104 performs an inverse fast Fourier transform of the multiplexed signal. The cyclic prefix adding unit 105 adds part of the signal obtained by the IFFT processing as a cyclic prefix. The D/A conversion unit 106 converts an output signal from the cyclic prefix adding unit 105 into an analog signal. The RF unit (transmission system) 107 up-converts the analog signal output from the D/A conversion unit 106 into a signal in a transmission band and transmits it from the transmission/reception antenna 108. The transmission system of the base station transmits, for example, an OFDM signal.

The RF unit (reception system) 109 down-converts the signal received by the transmission/reception antenna 108 into a baseband signal. The system controller 110 converts the baseband signal into a digital signal. The baseband demodulating unit 111 data-demodulates the digital signal. If, for example, the baseband demodulating unit 111 is an OFDM receiver, it performs channel variation compensation and demodulation after a fast Fourier transform by an FT processing unit (not shown). The data decoding unit 112 obtains communication data or control data (control information unique to the base station or common control information which is common within the area) by performing channel decoding for the data-demodulated signal. The reception system of the base station receives, for example, an OFDM signal and a single-carrier signal.

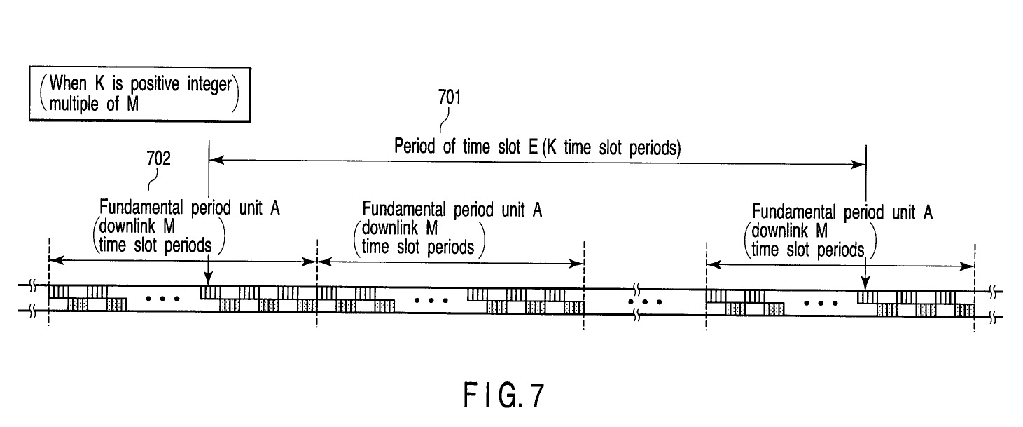

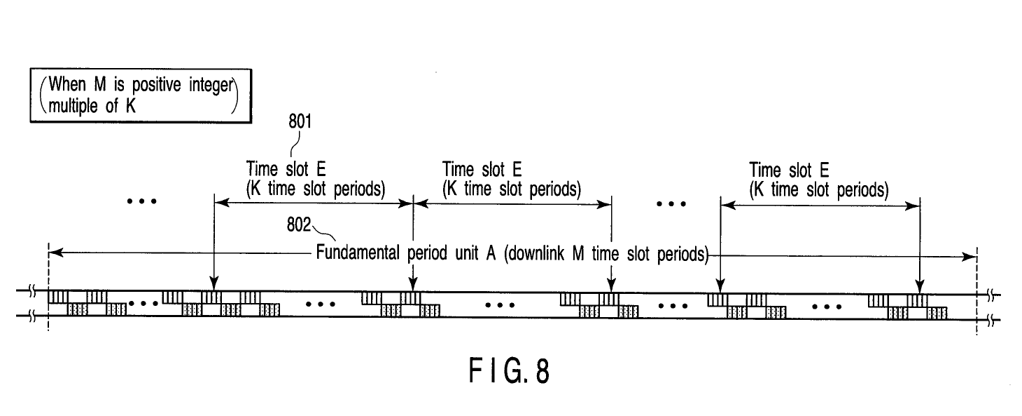

The control unit 113 controls the respective processing units of the transmission and reception systems and controls necessary operation timings such as synchronization with a slot. The control unit 113 outputs an instruction to the selector 102 to select and transmit intra-area common control information at the timing of a time slot in which the intra-area common control information is transmitted. The control unit 113 issues an instruction to carrier-sense that one of the time slots which has not been ensured in advance in a call area to which the base station belongs is not used. Upon checking an available time slot by carrier sense, the control unit 113 sets the available time slot as a candidate of a slot (a slot E in FIGS. 7 and 8) to be individually and intermittently used by each base station. Note that dotted arrows extending from the control unit 113 mainly indicate control signals.

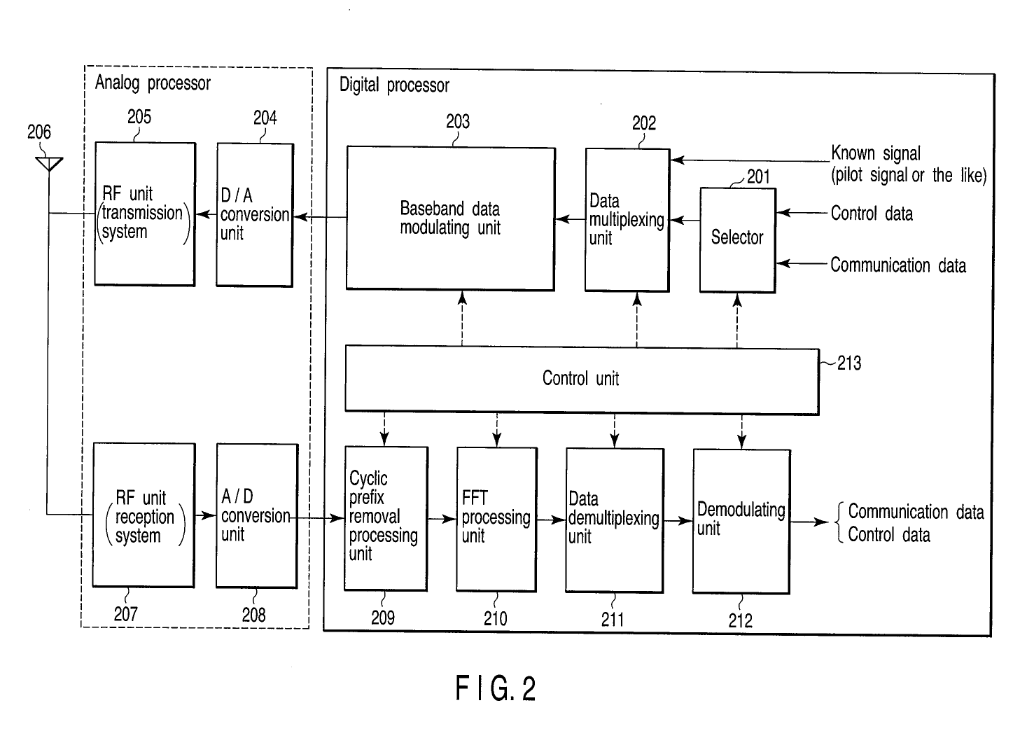

A terminal apparatus according to this embodiment will be described next with reference to FIG. 2.

The terminal according to this embodiment includes a selector 201, data multiplexing unit 202, baseband data modulating unit 203, D/A conversion unit 204, RF unit (transmission system) 205, transmission/reception antenna 206, RF unit (reception system) 207, A/D conversion unit 208, cyclic prefix removal processing unit 209, FFT processing unit 210, data demultiplexing unit 211, demodulating unit 212, and control unit 213.

The selector 201 modulates communication data and control data. The data multiplexing unit 202 multiplexes a known signal such as a pilot signal with data selected by the selector 201. The baseband data modulating unit 203 data-modulates the multiplexed signal. The D/A conversion unit 204 converts the modulated signal into an analog signal. The RF unit (transmission system) 205 up-converts the analog signal output from the D/A conversion unit 204 into a signal in a transmission band and transmits it from the transmission/reception antenna 206. The transmission system of the terminal transmits, for example, an OFDM signal and a single-carrier signal.

The RF unit (reception system) 207 down-converts the signal received by the transmission/reception antenna 206 into a baseband signal. The A/D conversion unit 208 converts the baseband signal into a digital signal. The cyclic prefix removal processing unit 209 removes the cyclic prefix contained in the digital signal. The FFT processing unit 210 performs a fast Fourier transform of an output signal from the cyclic prefix removal processing unit 209. The data demultiplexing unit 211 demultiplexes the fast-Fourier-transformed signal into communication data and control data. The reception system of the terminal receives, for example, an OFDM signal.

Assume that a terminal in a standby state has grasped, from information notified from a base station, to which the call area itself belongs, and knows the timing of a time slot which is commonly used within the area to which it itself belongs. The terminal in the standby state has already received control information notified from the base station. The terminal has grasped, from this information, the timing of the time slot commonly used within the area, a repetitive period, and the like. Assume that all the terminals in the standby state which belong to each call area have periodically received a time slot commonly used within the area to which themselves belong.

A terminal which has received intra-area common paging information checks from the information whether it itself is called. If the terminal itself is called, the terminal searches for neighboring base stations and selects one connection destination base station corresponding to the call.

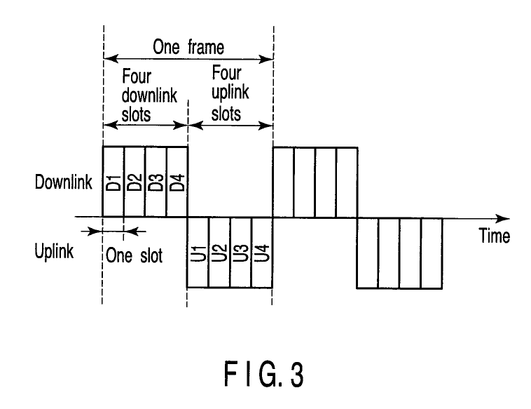

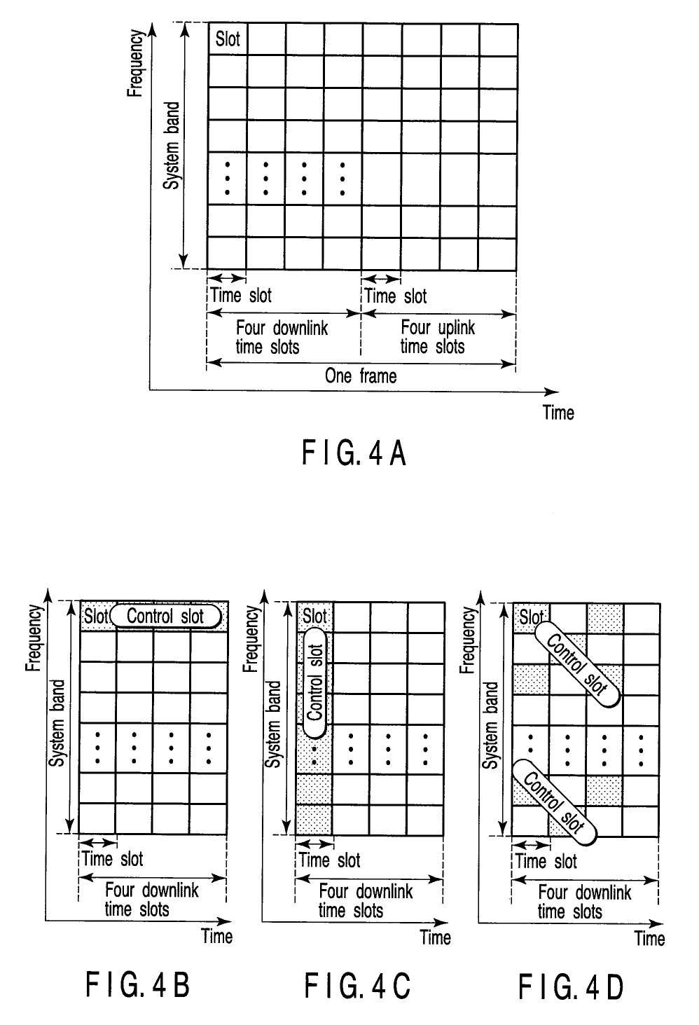

An example of the arrangement of slots exchanged between the base station in FIG. 1 and the terminal in FIG. 2 will be described next with reference to FIGS. 3 and 4.

The radio communication system of this embodiment uses a four-slot arrangement each on a downlink and an uplink in the time-axis direction, as shown in FIG. 3. In the frequency-axis direction, as indicated by FIG. 4A, the system uses a slot arrangement which is divided into several bands by a predetermined frequency bandwidth. In this radio communication system, a base station and a terminal communicate with each other by using slots sorted according to time/frequency as indicated by FIG. 4A. Assume that in this radio system, in order to transmit a control channel, each base station uses a predetermined specific slot of the slots sorted as indicated by FIG. 4A.

The forms of using such slots may include, for example, the frequency multiplexing form of using all the slots in a specific band as control slots as indicated by FIG. 4B, the time multiplexing form of using all specific time slots as control time slots as indicated by FIG. 4C, and the time/frequency multiplexing form of using slots in specific portions on the time and frequency axes as indicated by FIG. 4D as control slots.

This embodiment and other embodiments will exemplify a case wherein an entire specific band is used for control by frequency multiplexing indicated by FIG. 4B. Note, however, that a plurality of control channel bands may exist in the case indicated by FIG. 4B.

Assume that in the control channel band indicated by FIG. 4B, with time slots like those shown in FIG. 3, in order to transmit a control channel unique to each base station, each base station independently selects a time slot to be used upon checking it by itself by carrier sense or the like at the time of initial startup after the installation of the base station or re-startup, or when no connection is made to a terminal, for example, late at night or during a maintenance period. Assume that in this embodiment, since TDD is used, time slots to be uniquely used by each base station are corresponding time slots to be used in pairs on an uplink and a downlink. That is, for example, as shown in FIG. 3, when a base station uses a downlink slot D2, the base station also uses an uplink slot U2. Assume also that each base station time-divisionally and intermittently transmits a control channel unique to the base station by using a time slot for the transmission of the control channel unique to the base station at a predetermined period.

The arrangement of cells in which base stations are arranged will be described next with reference to FIG. 5.

In this embodiment, as shown in FIG. 5, a plurality of areas each comprising a plurality of base stations are prepared. Referring to FIG. 5, each area comprises 43 cells (one base station corresponds to each cell) and has the same shape. However, the numbers of base stations belonging to the respective areas may differ and have different shapes. Assume that in this embodiment, in each area, all the base stations transmit the same terminal call control information.

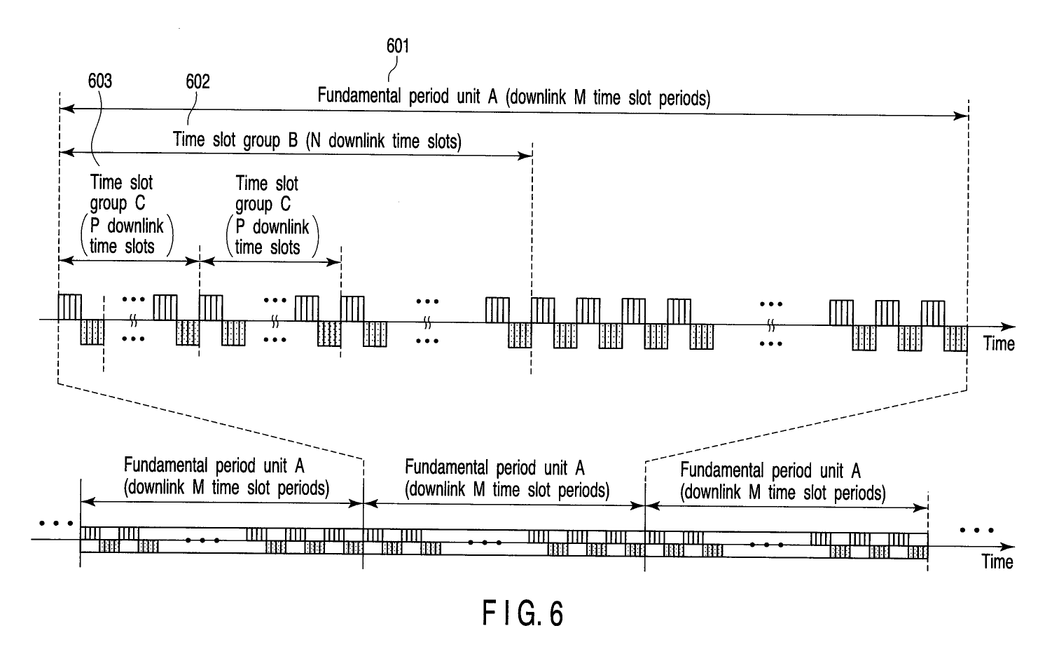

Slot groups assigned to the respective areas shown in FIG. 5 will be described next with reference to FIG. 6.

FIG. 6 shows a time slot fundamental period unit A 601 with a downlink M time slot period, which includes one time slot group B 602 comprising N time slots of the M time slots of the fundamental period unit A 601. FIG. 6 shows N time slots as if they were temporally continuous. However, N time slots may be arranged temporally randomly. In addition, a time slot group B comprising N slots is divided into time slot groups C 603 each comprising P time slots, and each time slot group C 603 is assigned to each area shown in FIG. 5. In this case, the time slot group C 603 assigned to each area may be selected from discontinuous time slots of the time slot group B 602.

As shown in FIG. 6, therefore, since one time slot group C is assigned to one area, each M time slot period of the fundamental period unit A 601 always includes at least one time slot group C assigned to each area. That is, an M time slot period of the time slot fundamental period unit A 601 means the transmission period of a time slot assigned to each area in advance.

Referring to FIG. 6, under the assumption of the case of FIG. 4B, the fundamental period unit A 601 comprises slots which are continuous in the time direction. However, the present invention is not limited to this. The time slot fundamental period unit A 601 can be set to a predetermined time interval, and slots included in the time interval can be arranged in advance in a specific pattern along the time/frequency axis as indicated by FIG. 4C or 4D.

All the base stations in an area operate in synchronism with the slot arrangement in FIG. 6. Assume that all the base stations in an area to which a given one of the time slot groups C in FIG. 6 is assigned in advance transmit control information common to the area in synchronism with the timing of the time slot group.

The period of a time slot for allowing each base station to transmit control information unique to the base station will be described next with reference to FIGS. 7 and 8.

As shown in FIGS. 7 and 8, each base station uses a time slot E for the transmission of control information unique to the base station upon detecting by itself the availability of the time slot by carrier sense, and the time slot E is intermittently used at a period of K time slots.

One of the following represents the relationship between the time slot period M of the time slot fundamental period unit A 601 and a time slot period K at which the time slot E is intermittently used:

(1) K is a positive integer multiple of M (including K=M)

(2) M is a positive integer multiple of K (not including K=M)

Case (1) described above is a case wherein a period 701 of the time slot E, which a base station has ensured to transmit control information unique to the base station, is longer than the period of a fundamental period unit A 702 of time slots including a time slot to be commonly used within the area.

Case (2) described above is a case wherein a fundamental period unit A 802 of time slots including a time slot to be commonly used within the area is longer than a period 801 of the time slot E which the base station has ensured to transmit control information unique to the base station.

In case (2) described above, the control unit 113 of the base station gives an instruction to carrier-sense that a time slot which has not been ensured by the call area to which the base station belongs is not used. Upon confirming by carrier sense that the time slot is available, the base station performs carrier sense in one or more time slots spaced apart from the available time slot by K time slot periods. Upon determining that one or more time slots are available, the control unit 113 selects the available time slot, and sets it as a slot which each base station uniquely and intermittently uses.

Such a condition is one of the parameters, and can be applied to either of the above cases in all the embodiments including this embodiment.

All the embodiments will be described below on the assumption of K=M.

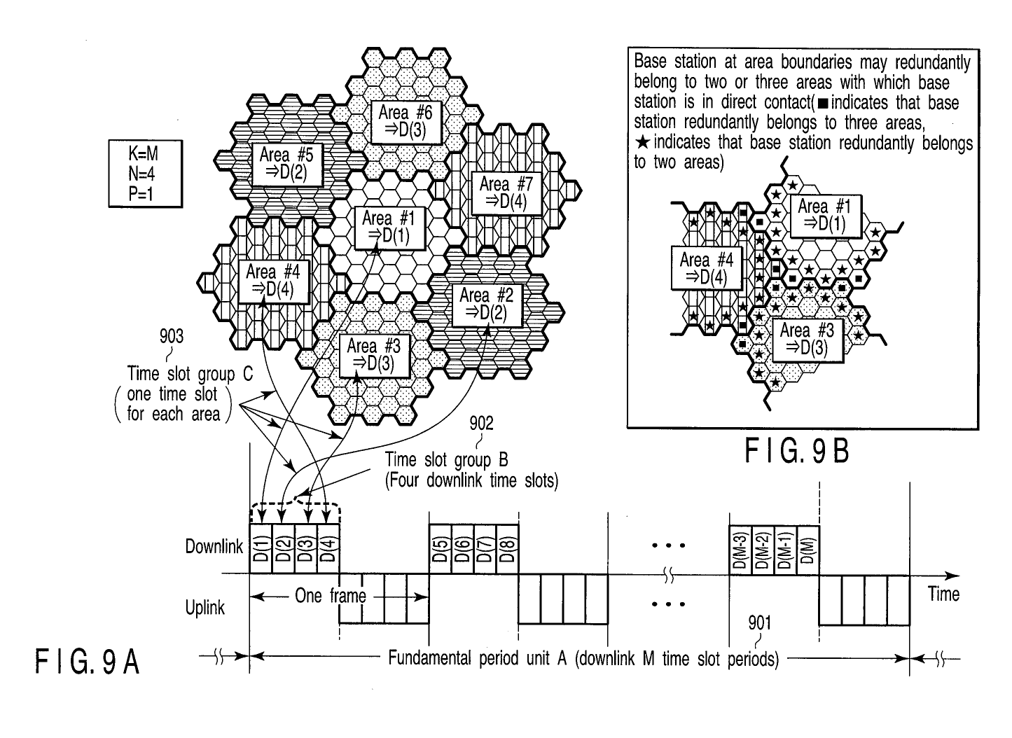

An example of assigning one slot to each area will be described next with reference to FIGS. 9A and 9B.

As indicated by FIG. 9A, a time slot group B 902 comprising N time slots is assigned to each area in advance within a fundamental period unit A 901 of M time slots on the downlink. In this case, since N=4 and P=1, a time slot group C comprises four time slots D(1), D(2), D(3), and D(4) and one time slot (time slot group C 903) is assigned to each area. For example, referring to FIG. 9A, the time slot D(1) is assigned to area #1, the time slot D(2) is assigned to area #2, the time slot D(3) is assigned to area #3, and the time slot D(4) is assigned to area #4. Assume that a time slot assigned to a given area is different from a time slot assigned to an area directly adjacent to the given area. For example, the time slot D(2) is assigned to area #5, the time slot D(3) is assigned to area #6, and the time slot D(4) is assigned to area #7.

For example, in FIG. 9A, the time slot D(2) is assigned to area #2, and the same time slot D(2) is assigned to area #5 which is not adjacent to area #2. Referring to FIG. 9A, since N=4, time slots are periodically reused by being cyclically assigned to every four areas.

Although FIG. 9A and FIG. 5 show that each base station belongs to one area, a base station located at an area boundary may be set at the time of base station installation to redundantly belong to a plurality of areas, as indicated by in FIG. 9B without posing any problem.

For example, in the case indicated by FIG. 9B, the following settings are made at the time of base station installation. That is, each base station represented by a black rectangle is located at the three area boundaries between areas #1, #3, and #4, and hence redundantly belong to the three areas, and each base station represented by a black star is located at two area boundaries, and hence redundantly belongs to the two areas. It is also possible to change areas to which a base station redundantly belongs in accordance with changes in surrounding areas after installation.

Assume that a given area is a large terminal call area to which several ten or more base stations belong. In this area, the usage rates of time slots ensured in advance greatly differ at the center of the call area and the area boundary.

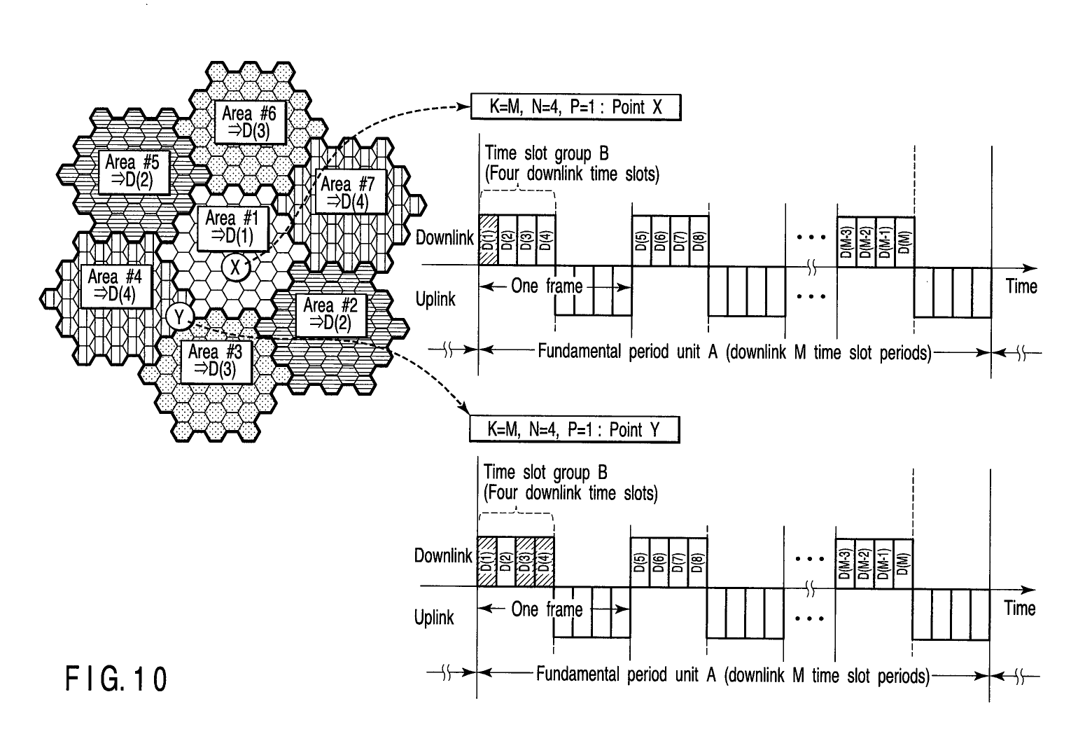

The usage rates of slots at the center of a call area and the area boundary will be described next with reference to FIG. 10.

FIG. 10 shows a state wherein the usage rate greatly changes depending on the position at which a base station is installed in a call area. For example, it is highly possible that at a point X in area #1 in FIG. 10, i.e., near the center of the area, only the time slot D(1) permanently ensured in advance for the area is being used. In contrast to this, at a point Y in FIG. 10, i.e., near the area boundaries between areas #1, #3, and #4, it is highly possible that the three time slots D(1), D(3), and D(4) permanently ensured in advance for the respective areas are being used.

The time slots of the time slot group B are permanently assigned to the respective areas in advance. However, these time slots are not exclusively used as time slots commonly used in the respective areas. That is, a base station confirms by carrier sense that even a time slot which is permanently ensured in advance, of time slots which the call area to which the base station belongs has not ensured in advance, is not used, and then handles the time slot which is not used as the slot E which is unique to each base station and the base station intermittently uses. Using the above arrangement makes it possible to increase the number of slot candidates which the respective base stations independently use.

As indicated by FIG. 9B, when a base station at an area boundary redundantly belongs to a plurality of areas, the base station transmits intra-area common paging in time slots assigned to the respective areas by the number of areas to which the base station belongs.

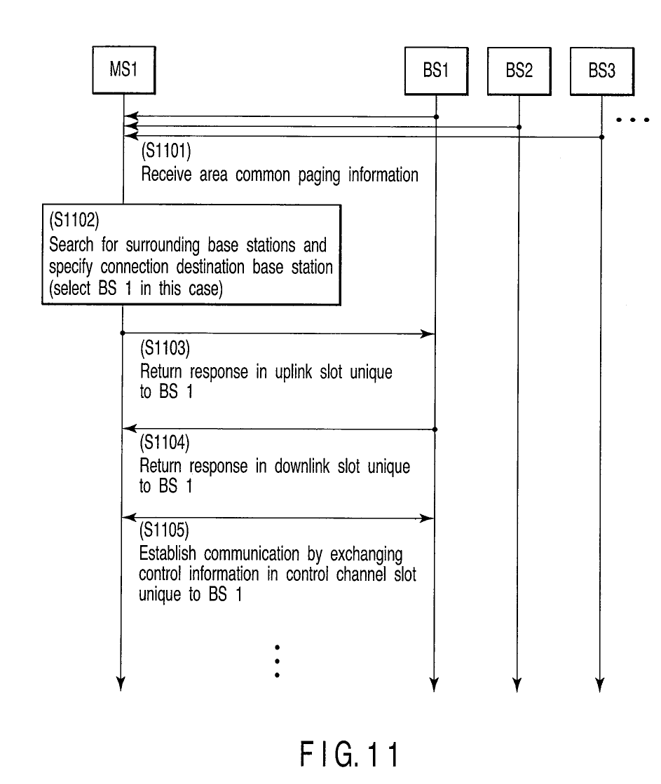

An example of a processing procedure for base stations and a terminal according to the first embodiment will be described next with reference to FIG. 11.

All base stations (BS 1, BS 2, BS 3, . . . ) in a call area transmit intra-area common paging information in time slots determined in advance for the respective call areas (step S1101). In each base station, the control unit 113 instructs the modulating unit 101 to modulate the intra-area common paging information (corresponding to the intra-area common control information in FIG. 1). The selector 102 then selects a signal, of the signals output from the plurality of modulating units 101, which contains the intra-area common control information, and transfers the selected signal to the data multiplexing unit 103. All the base stations in the area transmit the paging information over the same signal. Assume that the paging information contains information which allows to uniquely identify the terminal.

Assume also that a terminal (MS 1) in a standby state has grasped, from information broadcasted from a base station, to which the call area itself belongs, and knows in advance the position of the time slot group C which is commonly used in the call area to which it itself belongs. Assume, therefore, that all the terminals in the standby state in each call area periodically receive the time slot group C.

Upon receiving the intra-area common paging information, the terminal checks from the information whether it itself is called. If the terminal itself is called, the called terminal searches for neighboring base stations to determine a base station with which communication should be established, and selects one connection destination base station for the call (step S1102). Assume that a selection criterion is so set as to select a base station, of the base stations searched out, which has the highest reception power. If a base station search has been performed immediately before a call and the result has been stored, it suffices to select a connection destination base station by using the result. This operation is performed within the terminal by the technique which is well known to those skilled in the art.

The terminal then returns a response by using an uplink time slot unique to the selected base station and which is used by it (step S1103). Upon receiving the response in step S1103, the base station responds to the terminal by using a downlink slot unique to the base station (step S1104). The base station exchanges control information through a control channel slot unique to the base station, and establishes communication with the terminal (step S1105).

According to the procedure in FIG. 11, one called terminal is assumed. However, letting intra-area common paging information contain terminal identification information concerning a plurality of called terminals makes it possible to simultaneously call a plurality of terminals. In this case, a plurality of terminals which are called can cope with this situation by independently performing the processing from step S1102 to step S1105.

According to the first embodiment described above, as indicated by FIG. 9A, assigning a common time slot to each area makes it possible to improve the frequency usage efficiency as compared with a case wherein a time slot for the transmission of call information is ensured for each base station. In addition, as the number of base stations included in an area increases, a further improvement in frequency usage efficiency by sharing a time slot can be expected. When a time slot for the transmission of a control signal unique to a base station is detected and used as an available slot, the number of time slot selection candidates can be increased in a base station near the center of an area than in a base station at an area boundary by detecting a time slot, of the time slots assigned to the respective areas in advance, which is assigned to an area other than the area to which it itself belongs and setting the detected time slot as a selection candidate to be used. This makes it possible to implement more efficient time slot assignment. Furthermore, this can shorten the period during which terminal call information is transmitted as compared with a case wherein each base station multiplexes terminal call information in a time slot which each base station independently uses, and hence can shorten the time required between the instant a terminal is called to the instant communication is started.

### SECOND EMBODIMENT

In the second embodiment, as in the first embodiment, all the base stations in an area transmit the same signal in a time slot assigned to each area in advance, and each base station detects an available time slot of the time slots assigned to areas other than the area to which it itself belongs, and set the detected time slot as a slot candidate to be used for the transmission of control information unique to the base station.

This embodiment differs from the first embodiment in that each base station in an area transmits control information unique to the base station by using a time slot assigned in advance, other than a time slot which is assigned in advance to each call area and is used to transmit intra-area common paging information.

In this embodiment, unlike in the first embodiment, a base station controller (BSC) which comprehensively controls all base stations is installed. In this embodiment, unlike in the first embodiment, a plurality of base stations receive response signals to common call signals transmitted from base stations, and the base station controller selects a connection destination base station on the basis of a plurality of reception statuses.

Note that like the first embodiment, the second embodiment will be described on the assumption that K=M.

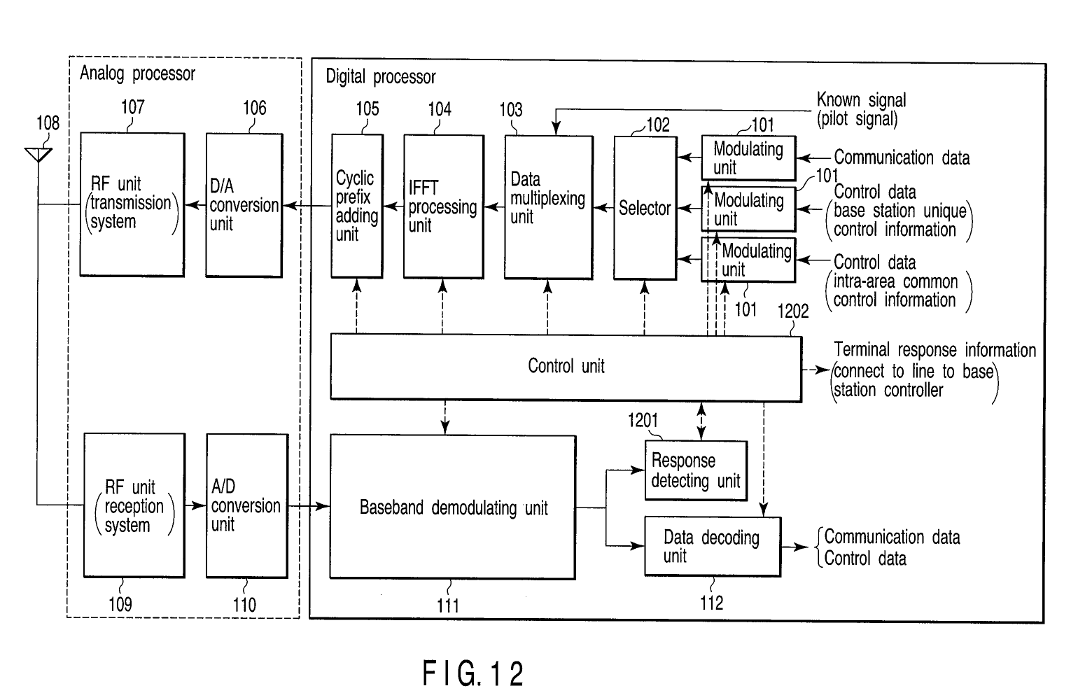

A base station according to this embodiment will be described with reference to FIG. 12. Note that a terminal in this embodiment is the same as that in the first embodiment.

The base station according to this embodiment additionally includes a response detecting unit 1201 as compared with the base station according to the first embodiment. Along with this addition, processing to be performed is added to the control unit.

The response detecting unit 1201 of the base station detects a response from a called terminal with respect to intra-area common paging information, and acquires, for example, the reception power of the response signal from the terminal which the base station has received and the reception time at which the base station has received the response signal from the terminal.

A control unit 1202 acquires a detection result (e.g., the reception power of a response signal and the reception time of the response time) from the response detecting unit 1201, and performs control to notify a base station controller 1501 (to be described later) of the detection result through a line through which the base station is connected to the base station controller. Other operations are the same as those of the control unit 113 in the first embodiment.

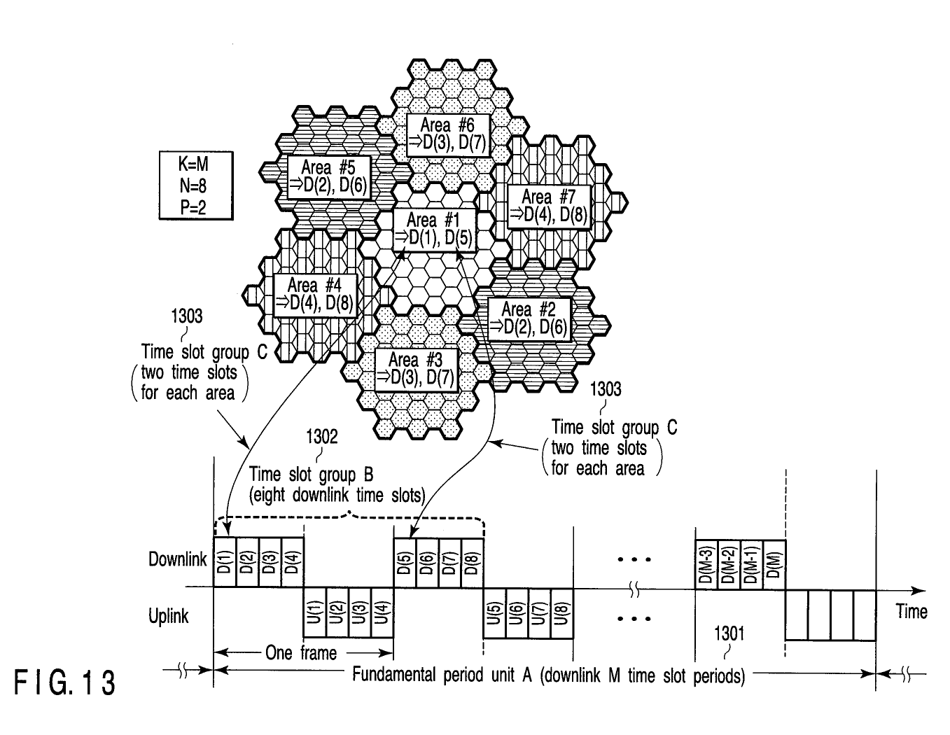

An example of assigning two slots to each area will be described next with reference to FIG. 13.

Assume that as shown in FIG. 13, the number (N) of time slots of a time slot group B 1302 is eight, and the number (P) of time slots of a time slot group C 1303 is two. This corresponds to the assignment of two time slots to each area.

For example, referring to FIG. 13, time slots D(2) and D(6) are assigned to area #2, and the same time slots D(2) and D(6) are assigned to area #5 which is not adjacent to area #2. In FIG. 13, assigned time slots are cyclically reused for every four areas.

Referring to FIG. 13, one of the two time slots assigned to each area is used for the transmission of intra-area common paging information by all the base stations in the area, and the other time slot is used for the transmission of unique control information to a terminal called by a specific base station. Note, however, that when transmitting intra-area common paging information, a plurality of base stations in the area transmit the same signal.

For example, in the time slot D(1) in area #1 in FIG. 13, intra-area common paging information is transmitted, while a specific base station in area #1 transmits a control signal to a called terminal in the time slot D(5). All the terminals in area #1 receive the intra-area common paging information in the time slot D(1), and the terminal which has been called by the call information returns a response in an uplink time slot corresponding to the time slot D(1). At this time, the terminal transmits the response signal while specifying no base station to which the response is to be returned.

In the case in FIG. 13 as well, as in the case described with reference to FIG. 9B in the first embodiment, no problem arises even when a base station located in a place where a plurality of areas are in direct contact with each other is set such that the base station belongs to the plurality of areas in direct contact with each other instead of only one area.

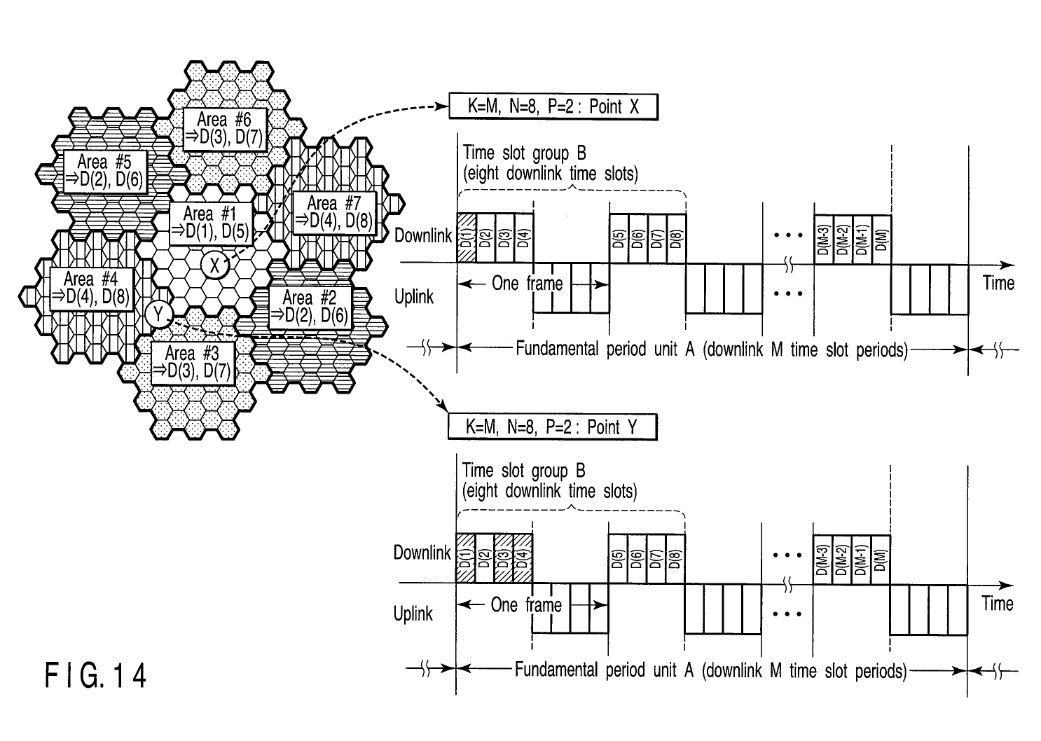

The usage rates of slots at the center of a call area and at area boundaries will be described next with reference to FIG. 14.

As described with reference to FIG. 10 in the first embodiment, time slots are used in different manners near the center of a call area and near area boundaries. For example, it is highly possible that at a point X in area #1 in FIG. 14, i.e., near the center of the area, only the two time slots D(1) and D(5) permanently assigned to the area are being used. In contrast to this, at a point Y in FIG. 14, i.e., near the area boundaries between areas #1, #3, and #4, it is highly possible that the six time slots D(1), D(3), D(4), D(5), D(7), and D(8) permanently assigned in advance to the respective areas are being used.

The time slots of the time slot group B are permanently ensured for the respective call areas in advance. However, these time slots ensured in advance are not exclusively used for the transmission of intra-area common paging information and control information unique to a specific base station. That is, each base station confirms by carrier sense that even time slots which are permanently assigned in advance are not used, and then confirms by itself that a time slot which is not used is not used by each base station, at the time of initial startup or re-startup or when no connection is made to a terminal, for example, late at night or during a maintenance period. The base station then can handle such a slot as a slot candidate to be used to intermittently transmit control information unique to the base station at a predetermined period. Therefore, frequencies can be used more efficiently as compared with the case wherein time slots are completely exclusively ensured.

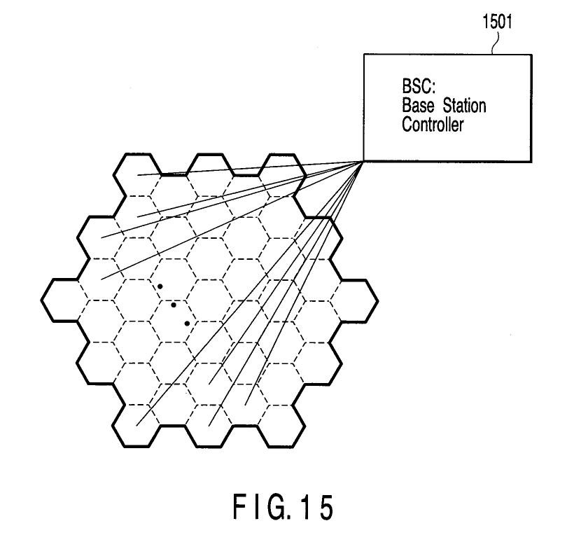

A base station controller which comprehensively controls all the base stations in an area will be described next with reference to FIG. 15.

The base station controller 1501 receives, from base stations, reception statuses which the base stations have received from a called terminal, and selects a base station to be made to communicate with the called terminal in accordance with the reception statuses. A reception status is, for example, the reception power of a response signal from a terminal which a base station has received or the reception time at which the base station has received the response signal from the terminal.

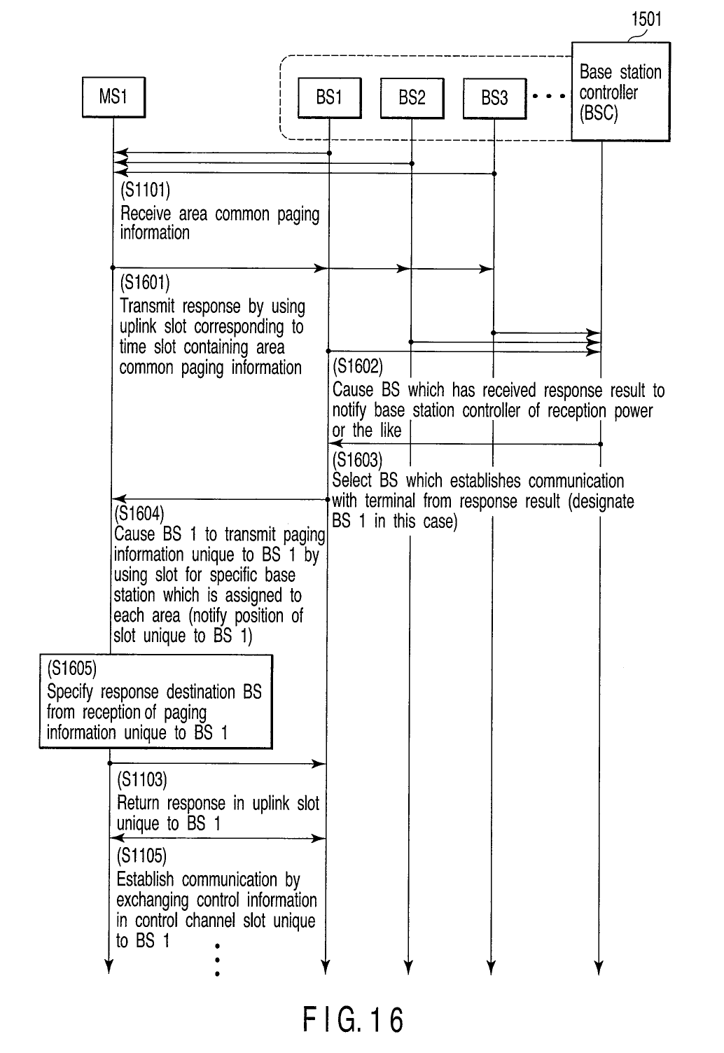

The base station controller 1501 selects, for example, a base station which has received a response signal with the highest reception power or one of a plurality of base stations which has received a response signal at the earliest reception time. The base station controller 1501 transmits an instruction signal to the selected specific base station (BS 1 in FIG. 16) to establish communication with the called terminal.

As shown in FIG. 15, all the base stations in an area can communicate with the base station controller 1501. Each base station communicates with the base station controller by wire connection in general. However, they may communicate by other means than wired connection, e.g., radio connection.

As indicated by FIG. 9B, assume that if a base station at area boundaries belong to a plurality of areas, connection is made such that the base station can communicate with base station controllers 1501 corresponding to all the areas to which the base station belongs.

An example of a processing procedure for base stations and a terminal according to the second embodiment will be described next with reference to FIG. 16. FIG. 16 shows a procedure from the instant a terminal receives intra-area common paging information to the instant the terminal starts communicating with a base station.

In step S1101 in FIG. 16, for example, a base station in area #1 in FIG. 13 transmits intra-area common paging information in the time slot D(1).

The called terminal (MS 1) transmits a response in an uplink slot corresponding to the time slot containing the intra-area common paging information (step S1601). The terminal MS 1 transmits a response by using an uplink time slot U(1) corresponding to the time slot D(1), as shown in FIG. 13. Assume that this response contains information, e.g., a terminal call number, which allows to uniquely identify a terminal. A base station (a plurality of base stations in general) located near the called terminal receives the response transmitted from this called terminal.

If the base stations which were located near the terminal MS 1 having transmitted the response signal and could receive the response signal are base stations BS 1, BS 2, and BS 3, the base stations BS 1 and BS 2, and BS 3 notify the base station controller 1501, which comprehensively controls base stations in the call area to which the base stations belong, of reception statuses (step S1602). A reception status which a base station notifies the base station controller is, for example, the reception power of a response signal or the reception time at which the base station has received the response signal.

The base station controller 1501 selects a base station to be made to communicate with the called terminal on the basis of the notified reception statuses. This selection criterion may be, for example, that a base station to be selected has received a response signal with the highest reception power or has received a response signal at the earliest reception time. The base station controller 1501 transmits an instruction signal to the selected specific base station (BS 1 in FIG. 16) to establish communication with the called terminal (step S1603).

The base station BS 1 which has received the instruction from the base station controller 1501 transmits control information unique to the base station BS 1 to the terminal MS 1 by using a time slot assigned in advance (e.g., the time slot D(5) in area #1 in FIG. 13) which is assigned to each call area in advance, other than a time slot in which intra-area common paging information has been transmitted (step S1604). The control information unique to the base station BS 1 contains control information for specifying the base station BS 1, e.g., a base station identification number or the position of the slot which the base station BS 1 uses. Receiving this information makes it possible to specify the base station BS 1 (step S1605).

In step S1103 in FIG. 16, a terminal MS 1 returns a response to the base station BS 1 by using an uplink slot of the time slot (e.g., the time slot D(5) in area #1 in FIG. 13) which the specified base station BS 1 uses to transmit/receive base station unique control information.

In step S1105 in FIG. 16, the base station BS 1 which has recognized the response exchanges unique control information with the called terminal BS 1 by using uplink and downlink time slots (e.g., the time slot D(5) and the corresponding uplink slot in area #1 in FIG. 13) which are used to transmit/receive the control information unique to the base station BS 1, thereby establishing a link.

### (Modification: for Plurality of Called Terminals)

The procedure in FIG. 16 in the second embodiment is based on the assumption that the intra-area common paging information transmitted in step S1101 in FIG. 16 contains information about one called terminal. However, this embodiment can be executed even when a plurality of terminals are called. In this modification, a time slot assigned to each area is based on the same conditions as those in the above case wherein one terminal is called as shown in FIG. 13.

In this modification, for example, in area #1 in FIG. 13, a time slot to be used by a called terminal to return a response is a time slot U(1). Therefore, responses from a plurality of called terminals are multiplexed by forming a plurality of subslots on this one time slot. That is, a base station divides the time slot U(1) into a plurality of subslots in advance, and when transmitting terminal call information in step S1101 in FIG. 16, designates a subslot number by which a response is to be returned, together with the identification information of the called terminal.

When one terminal is called as in the above case, a specific base station transmits its unique control information to the called terminal in the time slot D(5). In this modification, the time slot D(5) is divided into subslots like the time slot U(1). Each base station transmits its unique control information in a subslot designated when calling a terminal in the time slot D(1). Therefore, the time slots U(1) and D(5) have the same subslot arrangement. For example, techniques of dividing a time slot into subslots include frequency multiplexing by subcarrier division, time multiplexing by time division, and code multiplexing by code division.

Assume that intra-area common paging information contains pieces of information about two called terminals. In this case, the intra-area common paging information transmitted in the time slot D(1) contains pieces of terminal identification information of two called terminals and subslot numbers corresponding to the pieces of terminal identification information.

In the case of area #1 in step S1101 in FIG. 16, all the terminals in the area read the intra-area common paging information in the time slot D(1) and check whether they are called. The two called terminals transmit responses in subslots of the time slot U(1) which correspond to the subslot numbers designated by the intra-area common paging information.

Subsequently, the base station controller 1501 selects a response destination base station for each called terminal (steps S1602 and S1603). The specific base station then transmits its unique control information to each called terminal in subslots of the time slot D(5) which correspond to the subslot numbers designated when the terminals are called (step S1604). The procedure in step S1605 and subsequent steps is the same as that in the above case wherein one terminal is called, except that the procedure is independently proceeded for each called terminal.

According to the second embodiment described above, assigning a common time slot to each area as shown in FIG. 13 can improve the frequency usage efficiency as compared with the case wherein a time slot for the transmission of call information is ensured for each base station. As the number of base stations included in an area increases, a further improvement in frequency usage efficiency by sharing a time slot can be expected. In addition, since the period during which terminal call information is transmitted can be shortened as compared with the case wherein base stations multiplex pieces of terminal call information in time slots which the respective base stations independently use. This makes it possible to shorten the time required to start communication after a terminal calling operation.

In addition, the processing load on a terminal can be reduced by letting a base station controller select a base station to which the called terminal is to return a response and preparing a slot to be used by a specific base station after a terminal calling operation in addition to a slot commonly used by all the base stations in each area. This can implement a more efficient terminal calling operation.

Even when a plurality of terminals are to be called at the same time, the terminal calling operation can be efficiently performed by a procedure similar to that shown in FIG. 16 by using subslots as in this embodiment.

### THIRD EMBODIMENT

A characteristic feature of the third embodiment is that information unique to a base station is multiplexed on a time slot for the transmission of common call information for each area in addition to common call information for each area.

In the third embodiment, a base station checks whether a time slot assigned in advance to an area other than the area to which it itself belongs is not used by other base stations, and uses the time slot determined not being used to intermittently transmit control information unique to itself. This operation is the same as that in the first embodiment. In addition, as in the first embodiment, in the third embodiment, a terminal determines a connection destination base station. However, this embodiment uses a different technique for determination.

The third embodiment will be described on the assumption that K=M, as in the first and second embodiments.

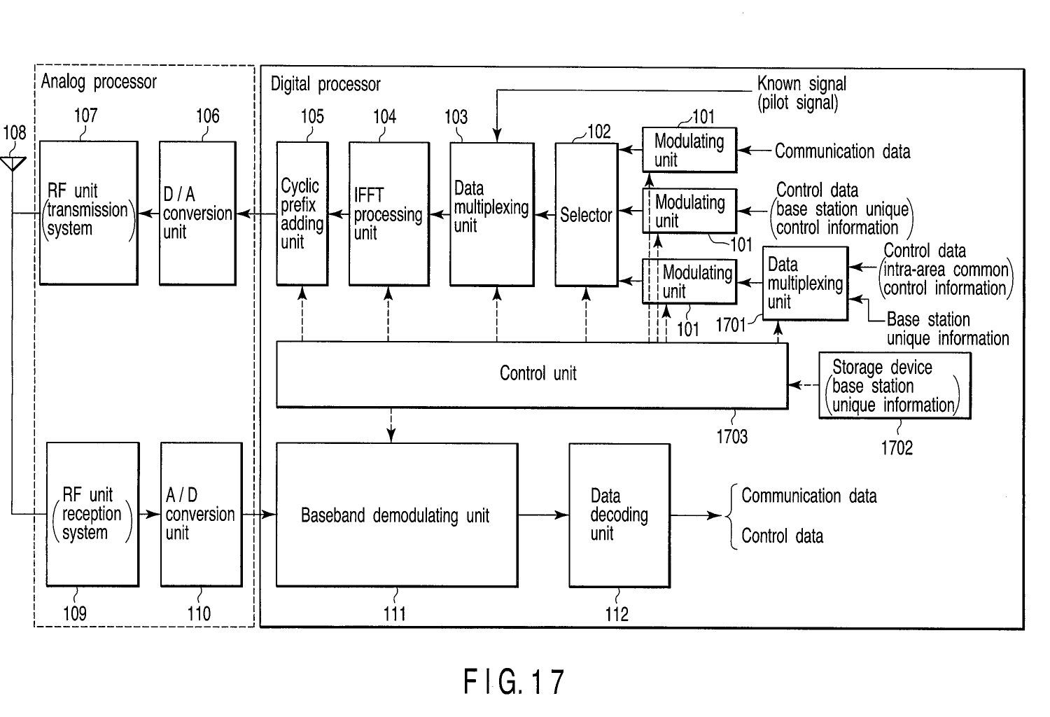

A base station according to this embodiment will be described with reference to FIG. 17.

The base station according to this embodiment additionally includes a data multiplexing unit 1701 and a storage device 1702 as compared with the base station according to the first embodiment. Along with this addition, processing to be performed is added to the control unit.

The data multiplexing unit 1701 multiplexes intra-area common paging information with information unique to the base station which is multiplexed on a time slot in which the intra-area common paging information is transmitted, and outputs the resultant information to a modulating unit 101. Information unique to the base station is, for example, the position information of a time slot unique to the base station, which only the base station uses to transmit a control signal.

The storage device 1702 stores information unique to the base station.

A control unit 1703 extracts the information unique to the base station from the storage device 1702, and supplies the information to the data multiplexing unit 1701. Other operations are the same as those by the control unit 113 in the first embodiment.

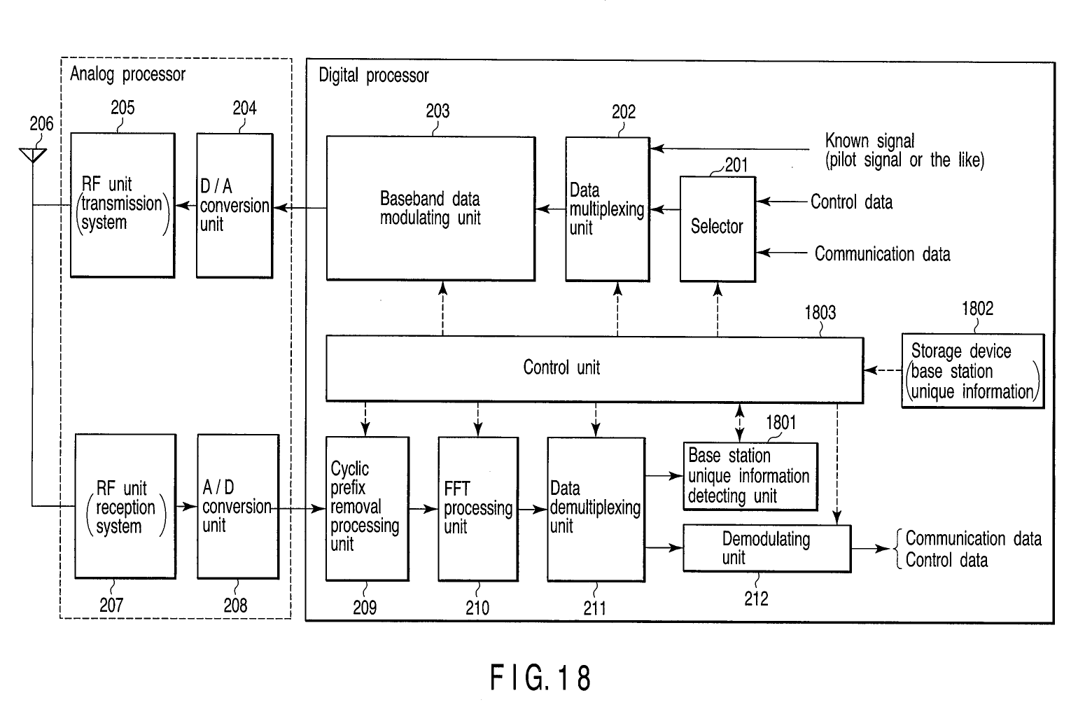

A terminal according to this embodiment will be described next with reference to FIG. 18.

The terminal according to this embodiment additionally includes a base station unique information detecting unit 1801 and a storage device 1802 as compared with the terminal according to the first embodiment. Along with this addition, processing to be performed is added to the control unit.

The base station unique information detecting unit 1801 calculates a correlation value between each orthogonal code sequence corresponding to each base station which is stored in the storage device 1802 and a reception signal from a base station, and outputs the correlation value to a control unit 1803.

The storage device 1802 stores a plurality of orthogonal code sequences corresponding to a plurality of base stations and the positions of time slots corresponding to the respective orthogonal code sequence in correspondence with each other.

The control unit 1803 checks intra-area common paging information and checks whether the self terminal is called. If the terminal itself is called, the control unit 1803 detects information unique to the base station (e.g., the position information of a time slot unique to the base station) multiplexed on a time slot in which the intra-area common paging information is transmitted. More specifically, the control unit 1803 supplies a plurality of orthogonal code sequences stored in the storage device 1802 to the base station unique information detecting unit 1801, and acquires a correlation value from the base station unique information detecting unit 1801. The control unit 1803 specifies a base station by detecting a orthogonal code sequence with a strong correlation, and detects the position of a time slot unique to the base station. Other operations are the same as those performed by the control unit 213 in the first embodiment.

In the third embodiment, it suffices to make the respective areas correspond to time slots assigned to the respective areas in advance as shown in FIG. 9. In addition, a technique of multiplexing information unique to a base station can be implemented by frequency multiplexing by subcarrier division, time multiplexing by time division, and code multiplexing by code division.

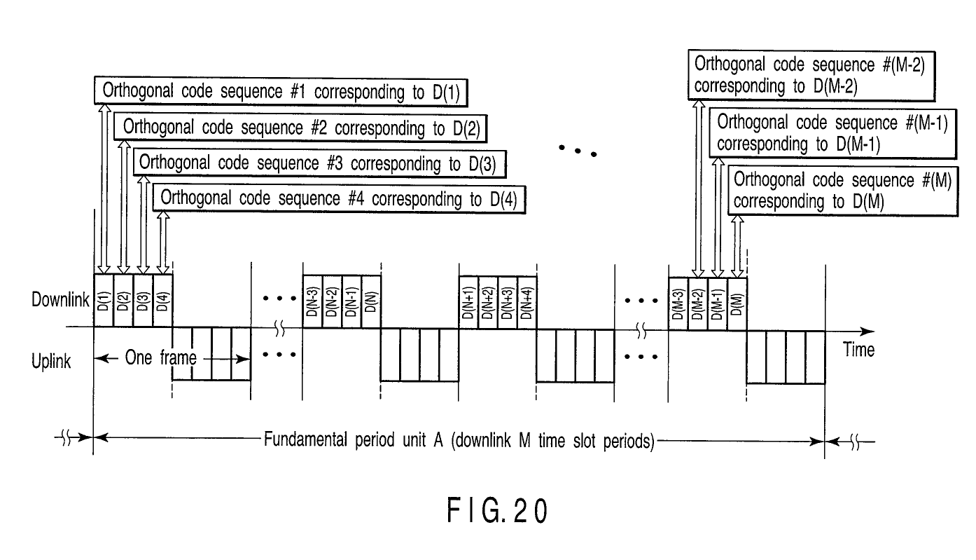

Information unique to the base station includes, for example, the position information of a time slot unique to the base station which only the base station uses to transmit a control signal. In this embodiment, a orthogonal code sequence is assigned to each time slot corresponding to one period of a fundamental period unit A in advance. As information unique to the base station, a orthogonal code sequence individually assigned to the base station is used. Assignment of orthogonal code sequences will be described later with reference to FIG. 20.

A terminal which has received common paging information in each area and been paged detects the position information of a time slot unique to the base station multiplexed on a time slot on which common call information for each area is multiplexed, i.e., a orthogonal code sequence.

If the terminal can detect information unique to the base station, i.e., a orthogonal code sequence, the terminal can specify in which slot in the fundamental period unit A the base station having transmitted the orthogonal code sequence has transmitted a control signal by calculation a correlation between a reception signal from the base station and a plurality of orthogonal code sequences as will be described later.

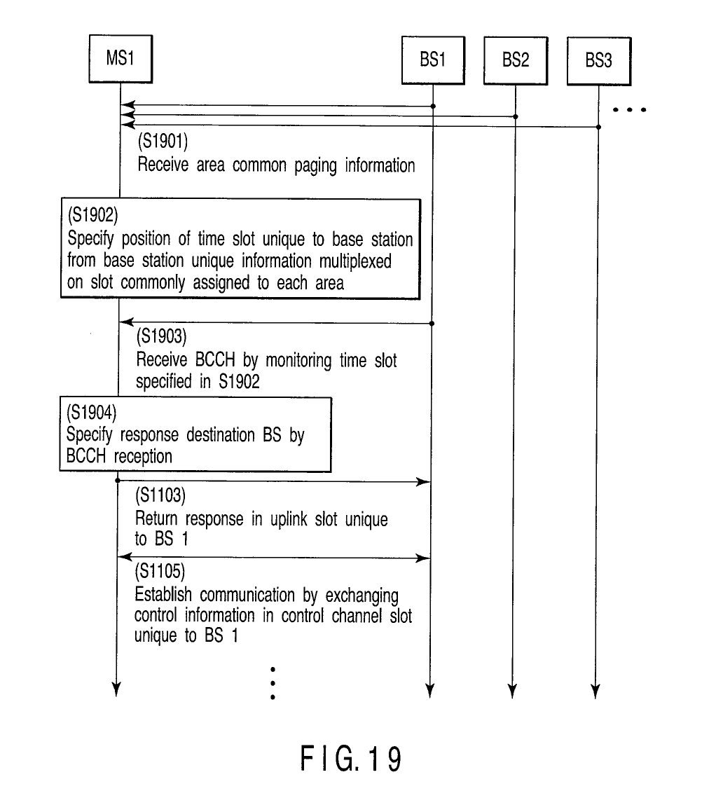

An example of a processing sequence for base stations and a terminal according to the third embodiment will be described next with reference to FIG. 19.

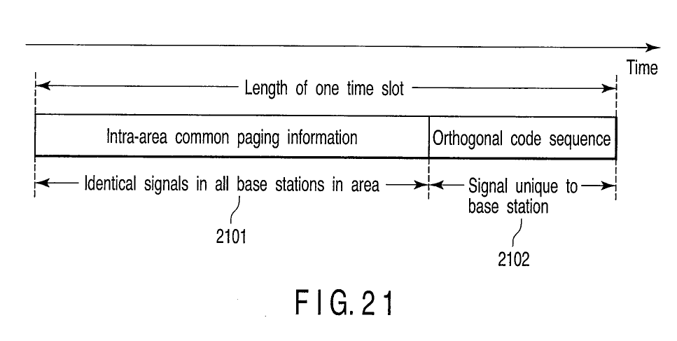

All the base stations (BS 1, BS 2, BS 3, . . . ) in the call area transmit, in the slot shown in FIG. 21, intra-area common paging information in a time slot assigned to each area in advance and information unique to the base station which is multiplexed on the time slot in which the intra-area common paging information is transmitted (step S1901).

Upon receiving the call information, the terminal (MS 1) sees the intra-area common paging information and checks whether the self terminal is called. If the self terminal is called, the terminal detects information unique to the base station which is multiplexed on the time slot in which the intra-area common paging information is transmitted, and specifies a time slot position (step S1902).

The terminal MS 1 receives and monitors the specified time slot position (step S1903). The terminal MS 1 receives a broadcast channel unique to the base station BS 1 by a monitoring operation in step S1903, and specifies a response destination base station (BS 1 in the case in FIG. 19) (step S1904).

The terminal returns a response to BS 1 by using an uplink time slot which BS 1 uses (step S1103). Thereafter, BS 1, which has recognized the response, can establish a link with MS 1 by exchanging control information with MS 1 by using uplink and downlink time slots which only BS 1 uses (step S1105).

As a orthogonal code sequence individually assigned as information unique to a base station to the base station, it suffices to use a code sequence which exhibits an acute peak at a code phase difference of 0 as an autocorrelation characteristic and exhibits sufficiently small absolute correlation values at all phase differences as a correlation characteristic.

A orthogonal code sequence individually assigned to a base station as information unique to the base station will be described with reference to FIGS. 20 and 21.

Orthogonal code sequences corresponding to K time slot periods which a base station uses to transmit control information unique to the base station upon checking availability are prepared, and time slot positions are made in advance to correspond to the respective orthogonal codes. In this embodiment, since K=M, M orthogonal code sequences are prepared in the case shown in FIG. 20.

In this case, when transmitting common call information for each area in a slot assigned to each area, the base station transmits the information upon dividing the time slot into a time interval 2101 in which all the base stations in the area transmit the same signal and a time interval 2102 in which the base station transmits a orthogonal code sequence unique to the base station. When transmitting this orthogonal code sequence, the base station may transmit the signal generated by modulating the orthogonal code sequence by, for example, BPSK or QPSK modulation, mapping the modulated symbol on a subcarrier, and performing IFFT processing for the resultant OFDM signal. Referring to FIG. 21, time multiplexing is used to implement the multiplexing of the time interval 2101 in which all the base stations transmit the same signal and the time interval 2102 in which the base station transmits a orthogonal code sequence unique to the base station. However, it suffices to use other multiplexing methods, e.g., a method of transmitting a orthogonal code sequence unique to a base station by using some subcarriers of a time slot and letting all the base stations transmit the same call signal by using the remaining subcarriers.

A base station unique information detecting unit 1801 of the terminal can detect which orthogonal code is multiplexed by acquiring a correlation between a reception signal and a orthogonal code sequence (step S1902). In addition, checking the magnitudes of correlation values and selecting a orthogonal code sequence exhibiting the largest correlation value can specify the position of a time slot which the response destination base station of the called terminal uses (step S1902).

In step S1902, however, the terminal which has received the intra-area common paging information obtains correlations between a reception signal in a time interval in which information unique to the base station is multiplexed and orthogonal code sequence candidates, and detects a orthogonal code sequence exhibiting the highest correlation value. Selecting a orthogonal code sequence exhibiting the highest correlation value makes it possible to specify the position of a time slot of an intermittent transmission period which a base station nearest to the called terminal MS 1 uses. The subsequent procedure is the same as that in steps S1903 to S1105 in FIG. 19.

In this case, the procedure in FIG. 19 is based on the assumption that one terminal is called. However, the procedure can be executed even when a plurality of terminals are called. For example, intra-area common paging information transmitted in step S1901 in the procedure in FIG. 19 may include information for identifying a plurality of called terminals. Each terminal in the area checks in step S1901 in the procedure in FIG. 19 whether it itself is called. If YES in step S1901, the called terminal may independently perform processing in step S1902 in subsequent steps.

According to the third embodiment described above, assigning a common time slot to each area as shown in FIG. 9 can improve the frequency usage efficiency as compared with the case wherein a time slot for the transmission of call information is ensured for each base station. In addition, as the number of base stations included in an area increases, a further improvement in frequency usage efficiency by sharing a time slot can be expected. Furthermore, this can shorten the period in which terminal call information is transmitted as compared with the case wherein each base station independently multiplexes terminal call information in a time slot which it itself uses. This can therefore shorten the time required to start communication after a terminal calling operation.

In addition, using information unique to a base station which is multiplexed on a time slot used for the transmission of intra-area common paging information allows the called terminal to specify a base station to which the terminal is to return a response. This can implement a more efficient terminal calling operation.

Specifying the position of a time slot which is used by a base station for intermittent transmission obviates the need to monitor all slots. That is, the base station is only required to monitor the position of a time slot specified in step S1902, and hence the processing of specifying a response destination base station can be reduced.

### FOURTH EMBODIMENT

The fourth embodiment specifies the position of a time slot unique to a base station by detecting a orthogonal code sequence contained in information unique to the base station, like the third embodiment, but returns a response to the call by using an uplink time slot corresponding to a time slot for the transmission of intra-area common paging information without specifying a response destination base station. The fourth embodiment differs from the third embodiment in that the base station recognizes the response, and individually transmits call information unique to the base station to the called terminal by using a slot different from a time slot, of the time slot group C assigned to each area, which contains the intra-area common paging information.

In the fourth embodiment, as in the second embodiment, areas are made to correspond to time slots assigned to the respective areas in advance in the manner shown in FIG. 13. Assume that orthogonal code sequences are made to correspond to the positions of time slots used by the respective base stations to transmit control signals unique to the base stations in the manner shown in FIG. 20, as in the third embodiment.

Like the first to third embodiments, the fourth embodiment will be described on the assumption that K=M.

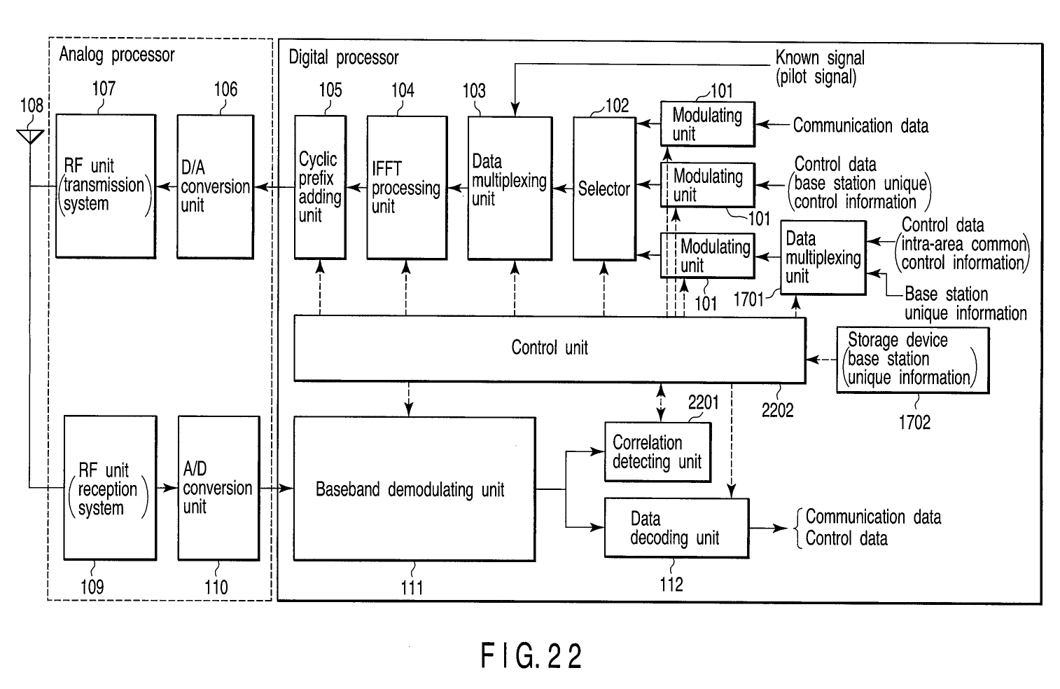

A base station according to this embodiment will be described with reference to FIG. 22.

The base station according to this embodiment additionally includes a correlation detecting unit 2201 as compared with the base station according to the third embodiment. Along with this addition, processing to be performed is added to the control unit.

The correlation detecting unit 2201 detects, on the basis of a correlation, whether a response signal from a terminal contains a orthogonal code sequence which it itself uses.

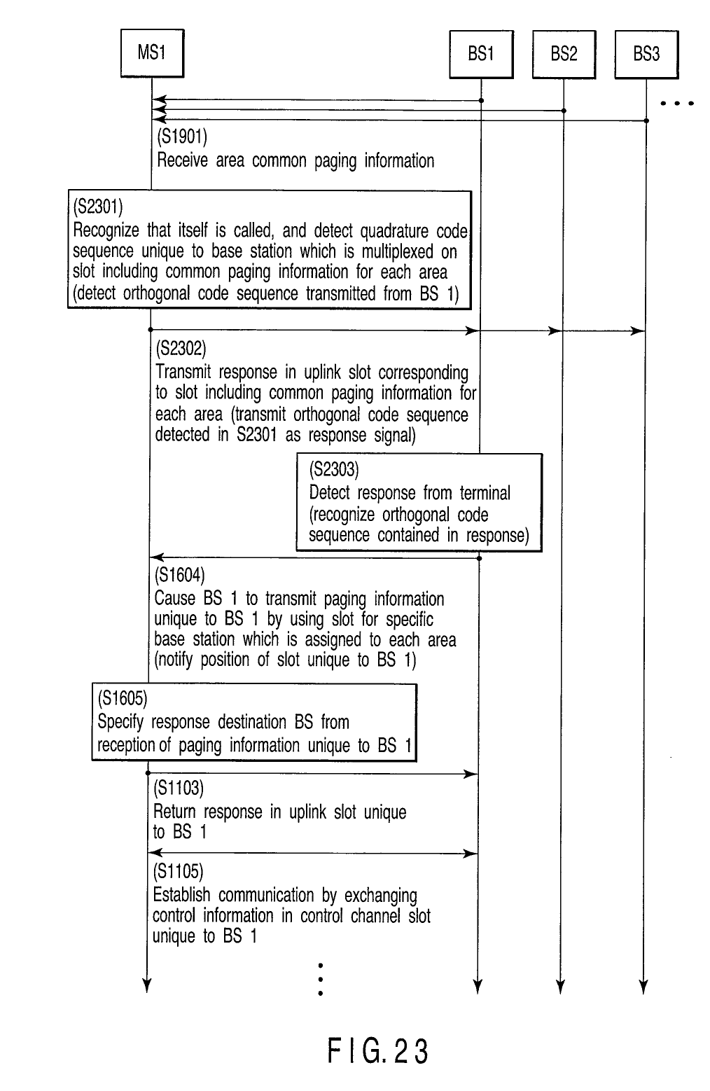

When the correlation detecting unit 2201 detects that a response signal contains a orthogonal code sequence which the self base station uses, a control unit 2202 adjusts a transmission timing so as to perform step S1604 in FIG. 23 and controls each processing unit to transmit call information unique to the base station in a proper time slot.

Note that a terminal in this embodiment is almost the same as that in the third embodiment, but slightly differs in the operation of a control unit 1803. That is, the control unit 1803 in the fourth embodiment inputs a orthogonal code sequence itself specified for the transmission of the orthogonal code sequence in step S2302 in FIG. 23 to a selector 201, and transmits a response such that the response contains the orthogonal code sequence.

Assume that on a time slot containing intra-area common paging information, information unique to a base station, i.e., a orthogonal code sequence, is multiplexed, as shown in FIG. 21. Referring to FIG. 21, time multiplexing is used to implement the multiplexing of the interval in which all the base stations transmit the same signal and the interval in which the base station transmits a orthogonal code sequence unique to the base station. However, it suffices to use other multiplexing methods, e.g., a method of transmitting a orthogonal code sequence unique to a base station by using some subcarriers of a time slot and letting all the base stations transmit the same call signal by using the remaining subcarriers.

In the third embodiment, when returning a response to a base station, a terminal transmits the response upon specifying to which base station it will return the response by using information unique to the base station which is multiplexed on a time slot containing intra-area common paging information. In the fourth embodiment, however, a terminal specifies the position of a time slot unique to a base station by detecting a orthogonal code contained in information unique to the base station as in the third embodiment, but returns a response to the call by using an uplink time slot corresponding to a time slot for the transmission of intra-area common paging information without specifying a response destination base station. The fourth embodiment differs from the third embodiment in that the base station recognizes the response from the terminal, and individually transmits call information unique to the base station to the called terminal by using a slot different from a time slot, of the time slot group C assigned to each area, which contains the intra-area common paging information.

For example, in area #1 in FIG. 13, all the base stations transmit intra-area common paging information in the time slot D(1), and a specific base station which has recognized a response from the called terminal transmits call information unique to the base station in the time slot D(5).

An example of a processing procedure for base stations and a terminal according to the fourth embodiment will be described next with reference to FIG. 23. The following will exemplify the case of area #1.

Intra-area common paging information is transmitted in the time slot D(1) determined in advance for each call area in FIG. 13 (step S1901). Assume that in the time slot D(1), a orthogonal code sequence unique to a base station as information unique to the base station is multiplexed and transmitted in addition to the intra-area common paging information.

A terminal which has received the intra-area common paging information checks whether it itself is called. If the terminal itself is called, the called terminal detects the orthogonal code sequence multiplexed on the time slot D(1) by acquiring a correlation (step S2301). For example, the base station unique information detecting unit 1801 and control unit 1803 extract a signal from a time interval in which the orthogonal code sequence is multiplexed or from a specific subcarrier, and select a orthogonal code sequence, of orthogonal code sequences as candidates, which exhibits the highest correlation value with respect to the extracted signal.

A called terminal MS 1 transmits a response to the call by using an uplink time slot corresponding to the time slot D(1) (step S2302). As a portion to be transmitted as a response in this case, the orthogonal code sequence specified in step S2301 is transmitted (step S2302).

Base stations (BS 1, BS 2, and BS 3 in FIG. 23) located near the called terminal MS 1 receive the response signal transmitted in step S2302. If each base station has grasped the orthogonal code sequence which it itself uses, making the correlation detecting unit 2201 check the correlation between the received response signal and the orthogonal code sequence which each base station has grasped allows each base station to identify whether the response is addressed to itself. Assume that in this case, a base station BS 1 has recognized the response from the called terminal BS 1 (step S2303).

Upon recognizing the response, the base station BS 1 transmits call information unique to the base station BS 1 to the terminal MS 1 by using the time slot D(5) in FIG. 13 which is assigned in advance for call information for each area (step S1604). This call information unique to the base station contains unique control information for specifying the base station BS 1, e.g., a base station identification number. Receiving this information makes it possible to specify the base station BS 1 (step S1605).

The called terminal MS 1 returns a response to the base station BS 1 by using an uplink time slot which the base station BS 1 individually uses (step S1103). Upon recognizing the response, the base station BS 1 can establish communication with the terminal MS 1 by exchanging control information with the terminal MS 1 by using uplink and downlink time slots which only the base station BS 1 uses (step S1105).

### (Modification: for Plurality of Called Terminals)

According to the procedure in FIG. 23 in the fourth embodiment, one terminal is called by intra-area common paging information transmitted in step S1901 in FIG. 23. However, this procedure can be executed even when a plurality of terminals are called. This modification differs from the modification of the second embodiment only in a processing procedure for base stations and a terminal (FIG. 23), but is the same in other respects.

This modification will be described with reference to FIG. 23 on the assumption that intra-area common information contains information about two called terminals, as in the modification of the second embodiment.

In step S1901 in FIG. 23, all the terminals in area #1 read intra-area common paging information in the time slot D(1) and check whether they are called (step S2301). Two called terminals each transmit a response by using a subslot of the time slot U(1) corresponding to a subslot number designated by the intra-area common paging information (step S2302).

For example, in area #1, each base station which has recognized the responses from the called terminals in step S2303 transmits individual call information to the called terminal in the subslots corresponding to the called terminals (step S1604).

Each called terminal can specify a response destination base station by receiving a subslot portion designated in the time slot D(5) (step S1605). The procedure in step S1103 and subsequent steps in FIG. 23 is the same as that in the fourth embodiment in which one terminal is called, except that the procedure is independently proceeded for each called terminal.

According to the fourth embodiment described above, assigning a common time slot to each area as shown in FIG. 13 can improve the frequency usage efficiency as compared with the case wherein a time slot for the transmission of call information is ensured for each base station. In addition, as the number of base stations included in an area increases, a further improvement in frequency usage efficiency by sharing a time slot can be expected. Furthermore, this can shorten the period in which terminal call information is transmitted as compared with the case wherein each base station independently multiplexes terminal call information in a time slot which it itself independently uses. This can therefore shorten the time required to start communication after a terminal calling operation.

In addition, a terminal detects information unique to a base station which is multiplexed on a time slot in which intra-area common paging information is transmitted and transmits the detected information as a response signal to the base station, thereby making the base station perform response destination base station specifying processing. This can reduce the processing on the terminal side in a call procedure.

Even when a plurality of terminals are to be simultaneously called, an efficient terminal calling operation can be implemented by a procedure similar to that in FIG. 23 by using subslots as in this embodiment.

### (Supplementary Explanation)

In the first to fourth embodiments, a time slot permanently assigned to each area is used to transmit terminal call information to a plurality of terminals in the same area. However, it is possible to use such a time slot to multicast control information simultaneously notified to a plurality of terminals, a broadcast program, and the like as well as call information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A base station apparatus comprising:
a first transmission unit configured to transmit area common information common to all base station apparatuses in an area by using not less than one time slot of not less than one common time slot assigned to each of a plurality of areas including a plurality of base station apparatuses, the common time slot being assigned to adjacent areas which are different from each other;
a carrier sense unit configured to perform carrier sense on a first time slot except for the common time slot assigned to the area to which the base station apparatus belongs;
a selection unit configured to select a second time slot determined as being available by the carrier sense; and
a second transmission unit configured to intermittently transmit a control signal unique to the base station apparatus in the second time slot at K (K: positive integer) time slot periods.

2. The apparatus according to claim 1, further comprising a multiplexing unit configured to multiplex information unique to the base station apparatus in the not less than one time slot, which transmits the area common information.

3. The apparatus according to claim 2, further comprising:
a reception unit configured to receive a response signal containing the unique information from a terminal apparatus designated by called terminal information contained in the area common information; and
a third transmission unit configured to, when the unique information is contained in a signal transmitted by the base station apparatus, transmit control information unique to the base station apparatus to the terminal apparatus designated by the called terminal information.

4. The apparatus according to claim 1, further comprising:
a first reception unit configured to receive a response signal from a terminal apparatus designated by paging information contained in the area common information;
a notification unit configured to notify a control apparatus of a reception status of the response signal, when receiving the response signal, the control apparatus controlling the plurality of base station apparatuses;
a second reception unit configured to receive an instruction signal from the control apparatus when the base station apparatus corresponds to one base station apparatus selected from the base station apparatuses by the control apparatus in accordance with a plurality of reception statuses, the instruction signal including an instruction to establish communication with the terminal apparatus; and
a third transmission unit configured to, when receiving the instruction signal, transmit unique control information of the base station apparatus to the terminal apparatus.

5. The apparatus according to claim 1, wherein the first transmission unit transmits the area common information to make all transmission signals in the time slot during which the area common information is transmitted identical with signals in the all base station apparatuses in the area.

6. The apparatus according to claim 1, wherein a transmission signal in the time slot during which the area common information is transmitted includes a first portion of a first signal identical with signals in all base station apparatuses in the area and a second portion of a second signal unique to the base station apparatus, and the first transmission unit transmits the area common information in the first portion, and transmits the second signal in the second portion.

7. A radio communication system which includes a plurality of base station apparatuses and a plurality of terminal apparatuses which perform radio communication by using time divided time slots,
each base station apparatus comprising:
a first transmission unit configured to transmit paging information for paging not less than one terminal apparatus as area common information common to all base station apparatuses in an area to which the base station apparatus belongs by using a common time slot common to the area, not less than one common time slot being assigned to each area including a plurality of base station apparatuses, different common time slots being assigned to adjacent areas;
a carrier sense unit configured to perform carrier sense on a first time slot except for the common time slot assigned to the area to which the base station apparatus belongs;
a first selection unit configured to select a second time slot determined as being available by the carrier sense; and
a second transmission unit configured to intermittently transmit a first control signal unique to the base station apparatus in the second time slot at K (K: positive integer) time slot periods, and
each terminal apparatus comprising:
a reception unit configured to receive the paging information;
a second selection unit configured to select a connection destination base station apparatus to which the terminal apparatus is to connect from a plurality of surrounding base station apparatuses when the paging information pages the terminal apparatus; and
a third transmission unit configured to transmit a response signal to the connection destination base station apparatus in a third time slot corresponding to a time slot which transmits a second control signal unique to the connection destination base station apparatus.

8. A radio communication system which includes a plurality of base station apparatuses and a plurality of terminal apparatus which perform radio communication by using time divided time slots, and further includes a control apparatus which controls the base station apparatuses,
each base station apparatus comprising:
a first transmission unit configured to transmit paging information for paging not less than one terminal apparatus as area common information common to all base station apparatuses in an area by using not less than one time slot of not less than one common time slot, not less than one common time slot assigned to each area including a plurality of base station apparatuses, different common time slots being assigned to adjacent areas;
a carrier sense unit configured to perform carrier sense on a first time slot except for the common time slot assigned to the area to which the base station apparatus belongs;
a first selection unit configured to select a second time slot determined as being available by the carrier sense; and
a second transmission unit configured to intermittently transmit a control signal unique to the base station apparatus in the second time slot at K (K: positive integer) time slot periods, and
each terminal apparatus comprising:
a first reception unit configured to receive the paging information;
a second selection unit configured to select a connection destination base station apparatus to which the terminal apparatus is to connect from a plurality of surrounding base station apparatuses when the paging information pages the terminal apparatus; and
a third transmission unit configured to transmit a response signal to the connection destination base station apparatus by using an uplink time slot corresponding to a downlink time slot during which paging information is transmitted,
each base station apparatus further comprising:
a second reception unit configured to receive the response signal; and
a fourth transmission unit configured to transmit a reception status of the response signal to the control apparatus when receiving the response signal;
the control apparatus comprising:
an acquisition unit configured to acquire a plurality of reception statuses by receiving the reception statuses from the base station apparatuses;
a third selection unit configured to select one base station apparatus from the base station apparatuses as a selected base station apparatus in accordance with the reception statuses; and
a fifth transmission unit configured to transmit, to the selected base station apparatus, an instruction signal containing an instruction to establish communication with the terminal apparatus, and
each base station apparatus further comprising:
a third reception unit configured to receive the instruction signal; and
a sixth transmission unit configured to, when receiving the instruction signal, transmit unique control information of each base station apparatus to a terminal apparatus designated by the paging information by using a third time slot, of common time slots of areas to which the base station apparatuses belong, which is different from a fourth time slot which transmits the area common information.

9. A radio communication system which includes a plurality of base station apparatuses and a plurality of terminal apparatuses which perform radio communication by using time divided time slots,
each base station apparatus comprising:
a first transmission unit configured to transmit a transmission signal of a common time slot of not less than one common time slot, the transmission signal including a first portion and a second portion, each common time slot being assigned to each area including a plurality of base station apparatuses, different common time slots being assigned to adjacent areas, the first portion including a first signal identical in all base station apparatuses in an area and, the second portion including a second signal unique to the base station apparatus, the first signal including paging information which designates not less than one terminal apparatus as area common information common to all base station apparatuses in the area;
a carrier sense unit configured to perform carrier sense on a first time slot except for the common time slot of the area to which the base station apparatus belongs;
a first selection unit configured to select an available time slot which is determined as being available by the carrier sense; and
a second transmission unit configured to intermittently transmit a control signal unique to the base station apparatus in the available time slot at K (K: positive integer) time slot periods, and
each terminal apparatus comprising:
a first reception unit configured to receive the paging information;
a second reception unit configured to receive the second signal;
a second selection unit configured to select a connection destination base station apparatus to which the terminal apparatus connects from a plurality of surrounding base station apparatuses in accordance with the second signal when the paging information paging the terminal apparatus;
a third reception unit configured to receive a broadcast signal from the connection destination base station apparatus at a position of a time slot which transmits the second signal; and
a third transmission unit configured to transmit a response signal to the connection destination base station apparatus by using an uplink time slot corresponding to a downlink time slot which transmits the control signal unique to the connection destination base station apparatus.

10. A terminal apparatus in a radio communication system, the apparatus comprising:
a first reception unit configured to receive paging information which pages a terminal apparatus as area common information common to all base station apparatuses in an area by using not less than one time slot of not less than one common time slot assigned to each area including a plurality of base station apparatuses, the common time slots being assigned to adjacent areas which are different from each other;
a transmission unit configured to transmit a response signal corresponding to the paging information; and
a second reception unit configured to receive unique control information of a base station apparatus which is transmitted by a first time slot other than a second time slot in which the paging information is transmitted, the first time slot being included in the common time slots.
